(19) United States
(12) Patent Application Publication
(10) Pub. No.: US 2024/0404228 A1
(43) Pub. Date: Dec. 5, 2024

(54) TECHNIQUES FOR MANAGING COMPUTER-GENERATED EXPERIENCES

(71) Applicant: Apple Inc., Cupertino, CA (US)

(72) Inventors: Owen MONSMA, Santa Clara, CA (US); Peter L. HAJAS, Lafayette, CO (US); James T. TURNER, San Jose, CA (US)

(21) Appl. No.: 18/619,568

(22) Filed: Mar. 28, 2024

Related U.S. Application Data
(60) Provisional application No. 63/471,257, filed on Jun. 5, 2023.

(51) Int. Cl. G06T 19/20; G06T 15/00

(52) U.S. Cl. CPC G06T 19/20; G06T 15/005

(57) ABSTRACT

Some techniques are described herein for managing computer-generated environments, including methods for managing the size of virtual objects and managing an experience.

### CROSS-REFERENCE TO RELATED APPLICATIONS

The present application claims priority to U.S. Provisional Patent Application Ser. No. 63/471,257 entitled “TECHNIQUES FOR MANAGING COMPUTER-GENERATED EXPERIENCES,” filed Jun. 5, 2023, which is hereby incorporated by reference in its entirety for all purposes.

### BACKGROUND

Today, people are using electronic device to attend more computer-generated experiences, including working, playing games, or attending events. There is a need to manage the computer-generated experiences to provide more value to more people.

### SUMMARY

Current techniques for managing computer-generated experiences are generally ineffective and/or inefficient. For example, some techniques require software developers to program solutions to manage computer-generated experiences independently, which can be time consuming and ineffective. This disclosure provides more effective and/or efficient techniques for managing computer-generated experiences for a computer system that can display virtual objects in immersive virtual environments. It should be recognized that other types of electronic devices can be used with techniques described herein. For example, computer systems that cannot display virtual objects in immersive virtual environments can be managed using the techniques described herein. In addition, techniques optionally complement or replace other techniques for managing three-dimensional environments.

Some techniques are described herein for managing the size of virtual objects as an environment or user interface that includes the virtual objects is resized. Such techniques provide techniques for maintaining the physical size of the virtual object or maintaining the actual size of the virtual object as the environment or user interface is resized.

In some examples, a method that is performed by a computer system is described. In some examples, the method comprises: receiving, from a first application, a request to render a first object in an environment; and in response to receiving the request to render the first object in the environment, rendering the first object; after rendering the first object and while the first object is being displayed in the environment, detecting an indication of a request to change a size of content provided by the first application; and in response to detecting the indication of the request to change the size of content provided by the first application, rendering a representation of the environment by: in accordance with a determination that the environment is rendered according to a first mode and that the first object is a first type of object, wherein the environment corresponds to the first application and a second application different from the first application while the environment is rendered according to the first mode, maintaining a physical size of the first object without maintaining an angular size of the first object; in accordance with a determination that the environment is rendered according to the first mode and that the first object is a second type of object different from the first type of object, maintaining the angular size of the first object without maintaining the physical size of the first object; and in accordance with a determination that the environment is rendered according to a second mode, wherein the environment corresponds to the first application without corresponding to another application different from the first application while the environment is rendered according to the second mode, maintaining the physical size of the first object without maintaining the angular size of the first object.

In some examples, a non-transitory computer-readable storage medium storing one or more programs configured to be executed by one or more processors of a computer system is described. In some examples, the one or more programs includes instructions for: receiving, from a first application, a request to render a first object in an environment; and in response to receiving the request to render the first object in the environment, rendering the first object; after rendering the first object and while the first object is being displayed in the environment, detecting an indication of a request to change a size of content provided by the first application; and in response to detecting the indication of the request to change the size of content provided by the first application, rendering a representation of the environment by: in accordance with a determination that the environment is rendered according to a first mode and that the first object is a first type of object, wherein the environment corresponds to the first application and a second application different from the first application while the environment is rendered according to the first mode, maintaining a physical size of the first object without maintaining an angular size of the first object; in accordance with a determination that the environment is rendered according to the first mode and that the first object is a second type of object different from the first type of object, maintaining the angular size of the first object without maintaining the physical size of the first object; and in accordance with a determination that the environment is rendered according to a second mode, wherein the environment corresponds to the first application without corresponding to another application different from the first application while the environment is rendered according to the second mode, maintaining the physical size of the first object without maintaining the angular size of the first object.

In some examples, a transitory computer-readable storage medium storing one or more programs configured to be executed by one or more processors of a computer system is described. In some examples, the one or more programs includes instructions for: receiving, from a first application, a request to render a first object in an environment; and in response to receiving the request to render the first object in the environment, rendering the first object; after rendering the first object and while the first object is being displayed in the environment, detecting an indication of a request to change a size of content provided by the first application; and in response to detecting the indication of the request to change the size of content provided by the first application, rendering a representation of the environment by: in accordance with a determination that the environment is rendered according to a first mode and that the first object is a first type of object, wherein the environment corresponds to the first application and a second application different from the first application while the environment is rendered according to the first mode, maintaining a physical size of the first object without maintaining an angular size of the first object; in accordance with a determination that the environment is rendered according to the first mode and that the first object is a second type of object different from the first type of object, maintaining the angular size of the first object without maintaining the physical size of the first object; and in accordance with a determination that the environment is rendered according to a second mode, wherein the environment corresponds to the first application without corresponding to another application different from the first application while the environment is rendered according to the second mode, maintaining the physical size of the first object without maintaining the angular size of the first object.

In some examples, a computer system comprising one or more processors and memory storing one or more programs configured to be executed by the one or more processors is described. In some examples, the one or more programs includes instructions for: receiving, from a first application, a request to render a first object in an environment; and in response to receiving the request to render the first object in the environment, rendering the first object; after rendering the first object and while the first object is being displayed in the environment, detecting an indication of a request to change a size of content provided by the first application; and in response to detecting the indication of the request to change the size of content provided by the first application, rendering a representation of the environment by: in accordance with a determination that the environment is rendered according to a first mode and that the first object is a first type of object, wherein the environment corresponds to the first application and a second application different from the first application while the environment is rendered according to the first mode, maintaining a physical size of the first object without maintaining an angular size of the first object; in accordance with a determination that the environment is rendered according to the first mode and that the first object is a second type of object different from the first type of object, maintaining the angular size of the first object without maintaining the physical size of the first object; and in accordance with a determination that the environment is rendered according to a second mode, wherein the environment corresponds to the first application without corresponding to another application different from the first application while the environment is rendered according to the second mode, maintaining the physical size of the first object without maintaining the angular size of the first object.

In some examples, a computer system is comprising means for performing each of the following steps: receiving, from a first application, a request to render a first object in an environment; and in response to receiving the request to render the first object in the environment, rendering the first object; after rendering the first object and while the first object is being displayed in the environment, detecting an indication of a request to change a size of content provided by the first application; and in response to detecting the indication of the request to change the size of content provided by the first application, rendering a representation of the environment by: in accordance with a determination that the environment is rendered according to a first mode and that the first object is a first type of object, wherein the environment corresponds to the first application and a second application different from the first application while the environment is rendered according to the first mode, maintaining a physical size of the first object without maintaining an angular size of the first object; in accordance with a determination that the environment is rendered according to the first mode and that the first object is a second type of object different from the first type of object, maintaining the angular size of the first object without maintaining the physical size of the first object; and in accordance with a determination that the environment is rendered according to a second mode, wherein the environment corresponds to the first application without corresponding to another application different from the first application while the environment is rendered according to the second mode, maintaining the physical size of the first object without maintaining the angular size of the first object.

In some examples, a computer program product is described. In some examples, the computer program product comprises one or more programs configured to be executed by one or more processors of a computer system. In some examples, the one or more programs include instructions for: receiving, from a first application, a request to render a first object in an environment; and in response to receiving the request to render the first object in the environment, rendering the first object; after rendering the first object and while the first object is being displayed in the environment, detecting an indication of a request to change a size of content provided by the first application; and in response to detecting the indication of the request to change the size of content provided by the first application, rendering a representation of the environment by: in accordance with a determination that the environment is rendered according to a first mode and that the first object is a first type of object, wherein the environment corresponds to the first application and a second application different from the first application while the environment is rendered according to the first mode, maintaining a physical size of the first object without maintaining an angular size of the first object; in accordance with a determination that the environment is rendered according to the first mode and that the first object is a second type of object different from the first type of object, maintaining the angular size of the first object without maintaining the physical size of the first object; and in accordance with a determination that the environment is rendered according to a second mode, wherein the environment corresponds to the first application without corresponding to another application different from the first application while the environment is rendered according to the second mode, maintaining the physical size of the first object without maintaining the angular size of the first object.

In some examples, a method that is performed by a computer system is described. In some examples, the method comprises: sending, from an application, a request for a pose associated with a user with respect to an origin of an experience for the application; and after sending the request for the pose associated with the user with respect to the origin of the experience for the application: in accordance with a determination that a first number of users are in the experience for the application: receiving a first pose; and rendering the experience for the application based on the first pose; and in accordance with a determination that a second number of users are in the experience for the application: receiving a second pose different from the first pose; and rendering the experience for the application based on the second pose.

In some examples, a non-transitory computer-readable storage medium storing one or more programs configured to be executed by one or more processors of a computer system is described. In some examples, the one or more programs includes instructions for: sending, from an application, a request for a pose associated with a user with respect to an origin of an experience for the application; and after sending the request for the pose associated with the user with respect to the origin of the experience for the application: in accordance with a determination that a first number of users are in the experience for the application: receiving a first pose; and rendering the experience for the application based on the first pose; and in accordance with a determination that a second number of users are in the experience for the application: receiving a second pose different from the first pose; and rendering the experience for the application based on the second pose.

In some examples, a transitory computer-readable storage medium storing one or more programs configured to be executed by one or more processors of a computer system is described. In some examples, the one or more programs includes instructions for: sending, from an application, a request for a pose associated with a user with respect to an origin of an experience for the application; and after sending the request for the pose associated with the user with respect to the origin of the experience for the application: in accordance with a determination that a first number of users are in the experience for the application: receiving a first pose; and rendering the experience for the application based on the first pose; and in accordance with a determination that a second number of users are in the experience for the application: receiving a second pose different from the first pose; and rendering the experience for the application based on the second pose.

In some examples, a computer system comprising one or more processors and memory storing one or more programs configured to be executed by the one or more processors is described. In some examples, the one or more programs includes instructions for: sending, from an application, a request for a pose associated with a user with respect to an origin of an experience for the application; and after sending the request for the pose associated with the user with respect to the origin of the experience for the application: in accordance with a determination that a first number of users are in the experience for the application: receiving a first pose; and rendering the experience for the application based on the first pose; and in accordance with a determination that a second number of users are in the experience for the application: receiving a second pose different from the first pose; and rendering the experience for the application based on the second pose.

In some examples, a computer system is comprising means for performing each of the following steps: sending, from an application, a request for a pose associated with a user with respect to an origin of an experience for the application; and after sending the request for the pose associated with the user with respect to the origin of the experience for the application: in accordance with a determination that a first number of users are in the experience for the application: receiving a first pose; and rendering the experience for the application based on the first pose; and in accordance with a determination that a second number of users are in the experience for the application: receiving a second pose different from the first pose; and rendering the experience for the application based on the second pose.

In some examples, a computer program product is described. In some examples, the computer program product comprises one or more programs configured to be executed by one or more processors of a computer system. In some examples, the one or more programs include instructions for: sending, from an application, a request for a pose associated with a user with respect to an origin of an experience for the application; and after sending the request for the pose associated with the user with respect to the origin of the experience for the application: in accordance with a determination that a first number of users are in the experience for the application: receiving a first pose; and rendering the experience for the application based on the first pose; and in accordance with a determination that a second number of users are in the experience for the application: receiving a second pose different from the first pose; and rendering the experience for the application based on the second pose.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described examples, reference should be made to the Detailed Description below, in conjunction with the following drawings in which like reference numerals refer to corresponding parts throughout the figures.

FIG. 1 illustrates an example system architecture including various electronic devices that may implement the subject system in accordance with some examples.

FIG. 2 illustrates a block diagram of example features of an electronic device in accordance with some examples.

FIG. 3 is a block diagram illustrating a computer system in accordance with some examples.

FIG. 4 is a block diagram for managing the size of virtual objects in accordance with some examples.

FIG. 5 is a flow diagram illustrating a method for managing the size of virtual objects in accordance with some examples.

FIGS. 6A-6B are user interfaces for managing an experience in accordance with some examples.

FIG. 7 is a flow diagram illustrating a method for managing an experience in accordance with some examples.

FIG. 8 illustrates an electronic system with which some examples of the subject technology may be implemented in accordance with some examples.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other examples. In some examples, structures and components are shown in block diagram form in order to avoid obscuring the concepts of the subject technology.

Methods and/or processes described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” “third,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described examples. In some examples, the first subsystem and the second subsystem are two separate references to the same subsystem. In some examples, the first subsystem and the second subsystem are both subsystems, but they are not the same subsystem or the same type of subsystem.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some examples, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

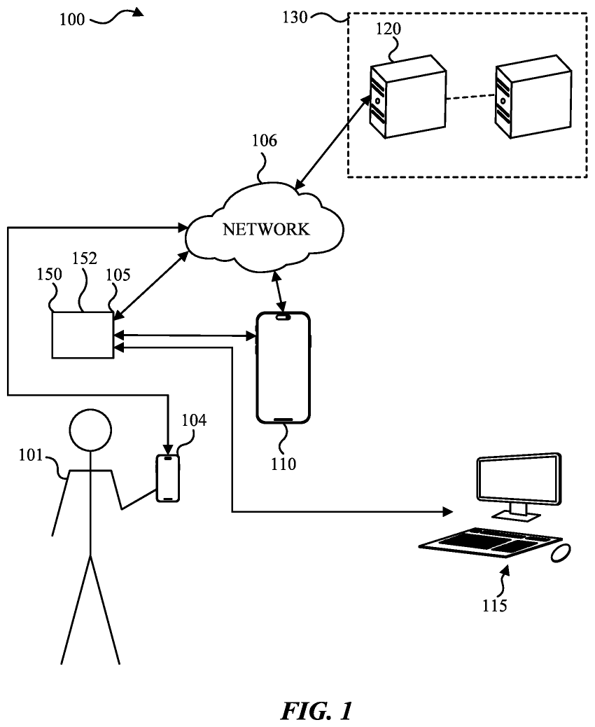

FIG. 1 illustrates an example system architecture 100 including various electronic devices that may implement the subject system in accordance with some examples. Not all of the depicted components may be used in all examples, however, and some examples may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, and a server 120. For explanatory purposes, the system architecture 100 is illustrated in FIG. 1 as including the electronic device 105, the handheld electronic device 104, the electronic device 110, the electronic device 115, and the server 120; however, the system architecture 100 may include any number of electronic devices, and any number of servers or a data center including multiple servers.

The electronic device 105 may be implemented, for example, as a tablet device, a smartphone, or as a head mountable portable system (e.g., worn by a user 101). The electronic device 105 includes a display system capable of presenting a visualization of an extended reality environment to the user. The electronic device 105 may be powered with a battery and/or another power supply. In an example, the display system of the electronic device 105 provides a stereoscopic presentation of the extended reality environment, enabling a three-dimensional visual display of a rendering of a particular scene, to the user. In some examples, instead of, or in addition to, utilizing the electronic device 105 to access an extended reality environment, the user may use a handheld electronic device 104, such as a tablet, watch, mobile device, and the like.

The electronic device 105 may include one or more cameras such as camera(s) 150 (e.g., visible light cameras, infrared cameras, etc.) For example, the electronic device 105 may include multiple cameras 150. For example, the multiple cameras 150 may include a left facing camera, a front facing camera, a right facing camera, a down facing camera, a left-down facing camera, a right-down facing camera, an up facing camera, one or more eye-facing cameras, and/or other cameras. Each of the cameras 150 may include one or more image sensors (e.g., charged coupled device (CCD) image sensors, complementary metal oxide semiconductor (CMOS) image sensors, or the like).

Further, the electronic device 105 may include various sensors 152 including, but not limited to, other cameras, other image sensors, touch sensors, microphones, inertial measurement units (IMU), heart rate sensors, temperature sensors, depth sensors (e.g., Lidar sensors, radar sensors, sonar sensors, time-of-flight sensors, etc.), GPS sensors, Wi-Fi sensors, near-field communications sensors, radio frequency sensors, etc. Moreover, the electronic device 105 may include hardware elements that can receive user input such as hardware buttons or switches. User inputs detected by such cameras, sensors, and/or hardware elements may correspond to, for example, various input modalities. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc. In some examples, facial tracking, gaze tracking, hand tracking, gesture tracking, object tracking, and/or physical environment mapping processes (e.g., system processes and/or application processes) may utilize images (e.g., image frames) captured by one or more image sensors of the cameras 150 and/or the sensors 152.

In some examples, the electronic device 105 may be communicatively coupled to a base device such as the electronic device 110 and/or the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 and/or providing power to the electronic device 105 while physically connected).

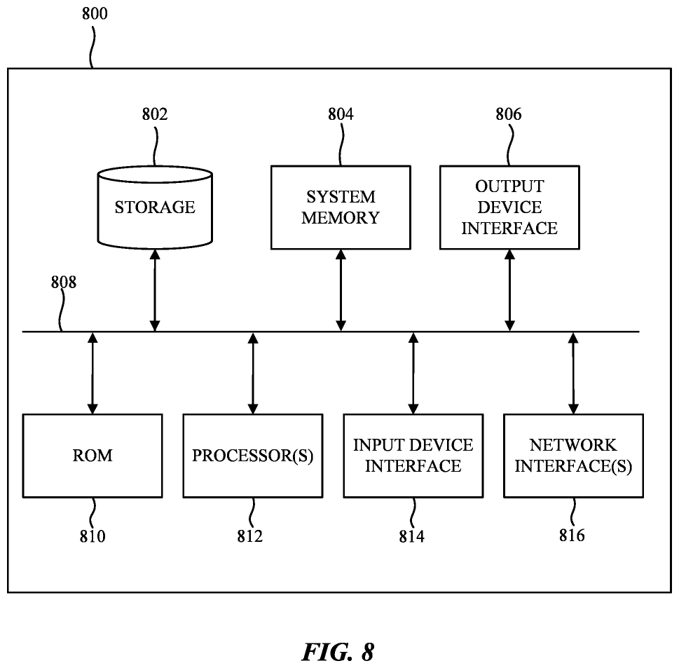

When the electronic device 105 operates in the wireless tethered mode or the connected mode, a least a portion of processing user inputs and/or rendering the extended reality environment may be offloaded to the base device thereby reducing processing burdens on the electronic device 105. For instance, in an example, the electronic device 105 works in conjunction with the electronic device 110 or the electronic device 115 to generate an extended reality environment including physical and/or virtual objects that enables different forms of interaction (e.g., visual, auditory, and/or physical or tactile interaction) between the user and the generated extended reality environment in a real-time manner. In an example, the electronic device 105 provides a rendering of a scene corresponding to the extended reality environment that can be perceived by the user and interacted with in a real-time manner, such as a host environment for a group session with another user. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload. The electronic device 105 may be, and/or may include all or part of, the electronic system discussed below with respect to FIG. 8.

The network 106 may communicatively (directly or indirectly) couple, for example, the electronic device 105, the electronic device 110, and/or the electronic device 115 with each other device and/or the server 120. In some examples, the network 106 may be an interconnected network of devices that may include, or may be communicatively coupled to, the Internet.

The handheld electronic device 104 may be, for example, a smartphone, a portable computing device such as a laptop computer, a companion device (e.g., a digital camera, headphones), a tablet device, a wearable device such as a watch, a band, and the like, or any other appropriate device that includes, for example, one or more speakers, communications circuitry, processing circuitry, memory, a touchscreen, and/or a touchpad. In some examples, the handheld electronic device 104 may not include a touchscreen but may support touchscreen-like gestures, such as in an extended reality environment. In some examples, the handheld electronic device 104 may include a touchpad. In FIG. 1, by way of example, the handheld electronic device 104 is depicted as a tablet device.

The electronic device 110 may be, for example, a smartphone, a portable computing device such as a laptop computer, a companion device (e.g., a digital camera, headphones), a tablet device, a wearable device such as a watch, a band, and the like, or any other appropriate device that includes, for example, one or more speakers, communications circuitry, processing circuitry, memory, a touchscreen, and/or a touchpad. In some examples, the electronic device 110 may not include a touchscreen but may support touchscreen-like gestures, such as in an extended reality environment. In some examples, the electronic device 110 may include a touchpad. In FIG. 1, by way of example, the electronic device 110 is depicted as a tablet device. In some examples, the electronic device 110, the handheld electronic device 104, and/or the electronic device 105 may be, and/or may include all or part of, the electronic system discussed below with respect to FIG. 8. In some examples, the electronic device 110 may be another device such as an Internet Protocol (IP) camera, a tablet, or a companion device such as an electronic stylus, etc.

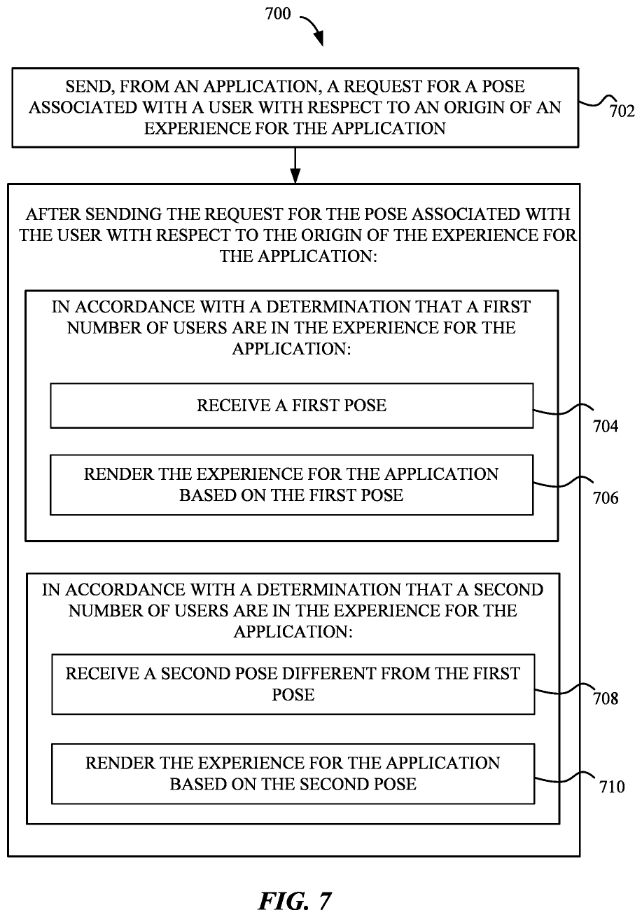

The electronic device 115 may be, for example, desktop computer, a portable computing device such as a laptop computer, a smartphone, a companion device (e.g., a digital camera, headphones), a tablet device, a wearable device such as a watch, a band, and the like. In FIG. 1, by way of example, the electronic device 115 is depicted as a desktop computer having one or more cameras 150 (e.g., multiple cameras 150). The electronic device 115 may be, and/or may include all or part of, the electronic system discussed below with respect to FIG. 7.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for extended reality environments. In an example, the server 120 may function as a cloud storage server that stores any of the aforementioned extended reality content generated by the above-discussed devices and/or the server 120.

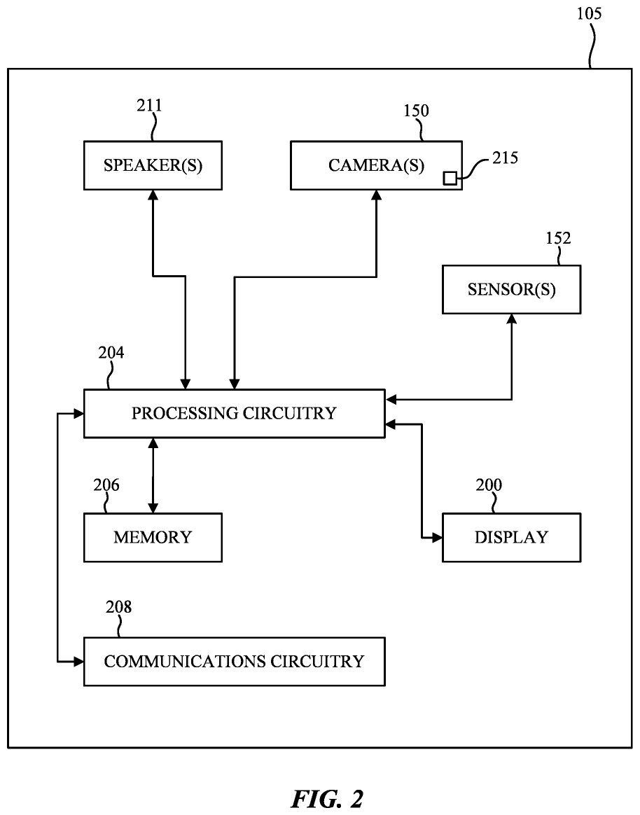

FIG. 2 illustrates a block diagram of various components that may be included in electronic device 105, in accordance with aspects of the disclosure. As shown in FIG. 2, electronic device 105 may include one or more cameras such as camera(s) 150 (e.g., multiple cameras 150, each including one or more image sensors 215) that capture images and/or video of the physical environment around the electronic device, one or more sensors 152 that obtain environment information (e.g., depth information) associated with the physical environment around the electronic device 105. Sensors 152 may include depth sensors (e.g., time-of-flight sensors, infrared sensors, radar, sonar, lidar, etc.), one or more microphones, and/or other types of sensors for sensing the physical environment. For example, one or more microphones included in the sensor(s) 152 may be operable to capture audio input from a user of the electronic device 105, such as a voice input corresponding to the user speaking into the microphones. In the example of FIG. 2, electronic device 105 also includes communications circuitry 208 for communication with electronic device 110, electronic device 115, servers 120, and/or other devices and/or systems in some examples. Communications circuitry 208 may include radio frequency (RF) communications circuitry for detecting radio frequency identification (RFID) tags, Bluetooth Low Energy (BLE) communications circuitry, other near-field communications (NFC) circuitry, WiFi communications circuitry, cellular communications circuitry, and/or other wired and/or wireless communications circuitry.

As shown, electronic device 105 includes processing circuitry 204 (e.g., one or more processors and/or integrated circuits) and memory 206. Memory 206 may store (e.g., temporarily or permanently) content generated by and/or otherwise obtained by electronic device 105. In some operational scenarios, memory 206 may temporarily store images of a physical environment captured by camera(s) 150, depth information corresponding to the images generated, for example, using a depth sensor of sensors 152, meshes and/or textures corresponding to the physical environment, virtual objects such as virtual objects generated by processing circuitry 204 to include virtual content, and/or virtual depth information for the virtual objects. Memory 206 may store (e.g., temporarily or permanently) intermediate images and/or information generated by processing circuitry 204 for combining the image(s) of the physical environment and the virtual objects and/or virtual image(s) to form, e.g., composite images for display by display 200, such as by compositing one or more virtual objects onto a pass-through video stream obtained from one or more of the cameras 150.

As shown, the electronic device 105 may include one or more speakers 211. The speakers may be operable to output audio content, including audio content stored and/or generated at the electronic device 105, and/or audio content received from a remote device or server via the communications circuitry 208.

Memory 206 may store instructions or code for execution by processing circuitry 204, such as, for example operating system code corresponding to an operating system installed on the electronic device 105, and application code corresponding to one or more applications installed on the electronic device 105. The operating system code and/or the application code, when executed, may correspond to one or more operating system level processes and/or application level processes, such as processes that support capture of images, obtaining and/or processing environmental condition information, and/or determination of inputs to the electronic device 105 and/or outputs (e.g., display content on display 200) from the electronic device 105.

In some examples, one or more input devices include one or more camera sensors (e.g., one or more optical sensors and/or one or more depth camera sensors such as for tracking a user's gestures (e.g., hand gestures and/or air gestures) as input. In some examples, the one or more input devices are integrated with the computer system. In some examples, the one or more input devices are separate from the computer system. In some examples, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

Attention is now directed towards techniques for managing computer-generated environments. Such techniques are described in the context of receiving a request from one or more applications and responding to those requests with information, such as information content the size of a virtual object and/or a pose within an experience of a person. It should be recognized that other configurations can be used with techniques described herein. In addition, techniques optionally complement or replace other techniques for managing computer-generated environments.

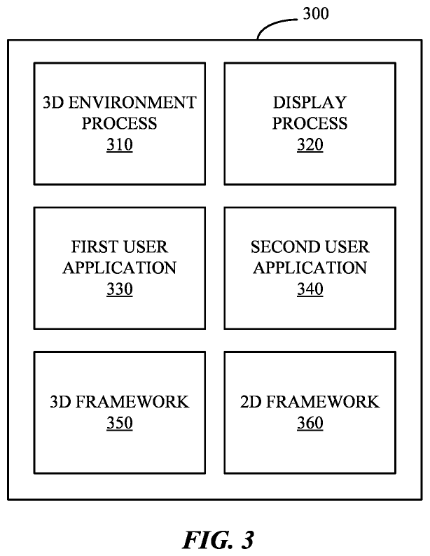

FIG. 3 is a block diagram illustrating a computer system (e.g., computer system 300) in accordance with some examples. Not all of the illustrated components are used in all examples; however, one or more examples can include additional and/or different components than those shown in FIG. 3. In some examples, computer system 300 includes one or more components described above with respect to electronic device 105, handheld electronic device 104, electronic device 110, electronic device 115, and/or server 120 as shown in FIG. 1. Variations in the arrangement and type of the components can be made without departing from the spirit or scope of the claims as set forth herein. Additional components, different components, and/or fewer components can be used as well.

In some examples, computer system 300 loads, renders, manages, and/or displays computer-generated content in a 3D environment. The 3D environment can be either virtual or physical, with the computer-generated content either completely covering a field of view of a user or supplementing the field of view. For example, computer system 300 can cause a virtual environment to be rendered and displayed to a user such that the user is provided content that is reactive to movements of the user. When the user moves around and performs different gestures, computer system 300 detects and processes the actions to provide tailored information to applications executing on computer system 300.

As illustrated in FIG. 3, computer system 300 includes 3D environment process 310, 3D framework 320 (e.g., a 3D UI framework and/or other type of 3D framework), 2D framework 330 (e.g., a 2D UI framework and/or other type of 2D framework), display process 340, first user application 350, and second user application 360. While FIG. 3 illustrates that each of these components are on a single computer system, it should be recognized that one or more components can be on another computer system in communication (e.g., wired and/or wireless communication) with computer system 300. In addition, while each component will be discussed separately, in some examples, the functionality of one or more components are combined together or separated further. In some examples, one or more components of computer system 300 communicate with other components via application programming interfaces (APIs), inter-process communications (IPCs), and/or serial peripheral interfaces (SPIs).

In some examples, 3D environment process 310 executes as a background process (e.g., a daemon, a service, a system process, an application process, and/or one or more instructions) to manage a 3D environment on behalf of one or more applications (e.g., first user application 350 and/or second user application 360). For example, 3D environment process 310 can create the 3D environment, manage a state of the 3D environment, receive requests from the one or more applications to render content in the 3D environment, communicate with 3D framework 320 and/or 2D framework 330 to service the requests, cause display process 340 to display the 3D environment, and/or detect and process inputs from a number of different sources.

In some examples, 3D environment process 310 provides one or more APIs to be used by the one or more applications for setting up the 3D environment. In such examples, the APIs can work in a declarative form that allows for developers to create views, animations, and/or other user-interface elements without needing to configure the 3D environment imperatively. In some examples, 3D environment process 310 creates a scene via a scene graph, adds one or more entities to the scene, and/or causes the scene to be rendered.

In some examples, 3D environment process 310 combines functionality of 3D framework 320 and 2D framework 330 such that user-interface elements and/or functionality provided by 3D framework 320 and/or 2D framework 330 can be used with each other rather than requiring one or the other to be used at a time. For example, 3D environment process 310 acts as a bridge between 3D framework 320 and 2D framework 330, providing each the ability to render objects together in a single scene. In some examples, 3D framework 320 renders 3D objects (e.g., via a first render server) and manages interactions with respect to the 3D objects and/or other objects. Similarly, 2D framework renders 2D objects (e.g., via a second render server different from the first render server) (e.g., and not 3D objects) and manages interactions with respect to the 2D objects and/or other objects. Rather than requiring each framework to work independently, such as providing a separate space for each to own, techniques described herein provide a single space that combines functionality of 3D framework 320 and 2D framework 330 to create the 3D environment. For example, as further discussed below, 2D environment can render objects to be used by 3D framework 320 when rendering the 3D environment.

In some examples, to perform such functionality described above, 3D environment process 310 creates a view (e.g., sometimes referred to as a world view) of a 3D environment and adds one or more 3D objects to the view. In such examples, an object of the one or more objects can be hidden, as described further below. In some examples, the object can be used by 3D framework 320 to maintain a place for 2D content from 2D framework 320. In such examples, one technique for implementing such is via a scene graph. The scene graph can include multiple 3D entities that are managed by environment process 310 and/or 3D framework 320. Such 3D entities can include both visible entities and hidden entities. In some examples, a hidden entity (e.g., sometimes referred to as an invisible and/or non-displayed entity) has a size, position, and/or orientation within the 3D environment. Moreover, the hidden entity is connected to a 2D entity such that 3D framework 320 communicates with 2D framework via the hidden entity and/or vice versa.

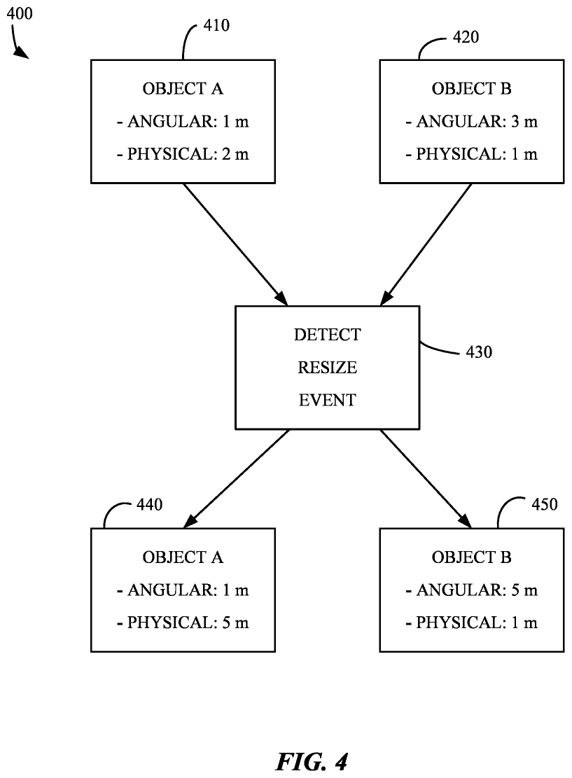

FIG. 4 is a block diagram that illustrates an exemplary embodiment for resizing an environment. In some examples, the techniques described below in relation to managing the size of virtual objects in an environment as display of the environment is resized. In some examples, the physical size of a virtual object is maintained, irrespective of whether the angular size of the virtual object is maintained. In some examples, the angular size of the virtual object is maintained, irrespective of the physical size of the virtual object.

In some examples, the decision to maintain the physical size or angular size of the virtual object is based on one or more characteristics associated with the virtual object. In some examples, if the one or more characteristics (e.g., such as a system flag, designation, type of virtual object, method parameter, etc.) designate for the physical size of the virtual object to be maintained, a computer system would provide information for resizing the virtual object, such that the physical size of the virtual object would be maintained and the angular size of the virtual object would not be maintained. In some examples, if the one or more characteristics designate for the angular size of the virtual object to be maintained, a computer system would provide information (e.g., in response to an API request) for resizing the virtual object, such that the angular size of the virtual object would be maintained and the physical size of the virtual object would not be maintained. In some examples, applications attempt to maintain the angular size and the physical size of virtual objects while resizing user interfaces and/or environment. However, in some examples, a choice as to whether to prioritize the maintaining of the physical size of the virtual object or the angular size of the virtual object during resizing operations needs to be made. For example, when resizing an object that has text in a virtual environment, a decision can be made to maintain the angular size of the text, irrespective of maintaining the physical size of the text (e.g., and/or the size at which the text was originally displayed and/or would be displayed in the physical environment). In some examples, this decision would allow the text to remain visible to the user as one or more portions in the environment is resized (e.g., get smaller and/or is zoomed out of). For example, when text is included on a billboard and a user's perspective with respect to the billboard becomes further away, the text can maintain the same size as the billboard becomes smaller, allowing the text to maintain its legibility to the user even as the billboard becomes smaller. As another example, when resizing an object that represents a building or structure in the virtual environment, a decision can be made to maintain the physical size of the object in the virtual environment, such that the original size of the virtual object is maintained, irrespective of whether one or more portions are resized (and/or zoomed). For example, the building can include a label that, as the building becomes smaller due to increased distance from a user, the name of the building maintains its angular size with respect to the user and does not become smaller even when the building does not maintain its angular size and becomes smaller.

FIG. 4 is block diagram 400 that includes object A state block 410 and object B state block 420. Object A state block 410 is a representation of properties that an object (e.g., object A) is tracked (e.g., by a computer system) as having while being presented in an environment. Similarly, object B state block 420 is a representation of properties that a different object is tracked as having while being presented in the environment. In some examples, the objects corresponding to object A state block 410 and object B state block 420 are concurrently displayed and/or presented together in a physical environment. In some examples, the objects (“the respective objects”) corresponding to object A state block 410 and object B state block 420 are hidden in the environment. In some examples, the respective objects are displayed in and/or hidden in content displayed in a mixed-reality and/or virtual-reality environment.

As represented in object A state block 410 and object B state block 412, object A currently is tracked as having an angular size of one meter and a physical size of two meters while object B is currently tracked as having an angular size of three meters and physical size of one meter. In some examples, object A and/or object B has different sizes than the one represented in object A state block 410 and object B state block 412. In some examples, one or more other properties related to size are tracked for object A and object B. In some examples, one or more properties of other objects are tracked for object A and object B.

At block 430, a computer system detects that a resize event has occurred. In some examples, the resize event does not include an indication to resize object A or object B. In some examples, it does. In some examples, the resize event is detected by receiving a request from an application. In some examples, the application sends the request via an API call to the computer system to determine the size that object A and/or object B after (or before) the resizing event has occurred.

Updated object A state block 430 and updated object B state block 450 are provided to show how the resizing event impacted object A and object B differently. Object A state block 430 indicates that object A is currently being tracked to have an angular size of one meter and a physical size of five meters. Thus, at block 430, object A's angular size has been maintained before and after the occurrent of the resizing event. However, object B's angular size has not been maintained. In fact, object B state block 412 object B's angular size has increased from three meters to five meters while the physical size of object B has remained the same at one meter (e.g., when comparing object B state block 420 to updated object B state block 450). In some examples, a computer system sends a response to an API call that indicates how object A and object B should be resized after the occurrence of the resizing event.

It should be understood that the scenario described above in relation to resizing objects in different manners and/or tracking can occur in many different user interfaces and/or environments. In some examples, the size of object A and object B are tracked while each of the objects are displayed in an application window, such as a two-dimensional window that is displayed on a surface or a three-dimensional window that is bounded. In some examples, whether the angular size or physical size is maintained is determined based on a particular mode in which a computer system is operating. For example, the physical size of a virtual object can be maintained while the computer system is operating in a two-dimensional and/or a window mode, where this paradigm can be switched (e.g., angular size maintained) after the computer system shift to operating in a three-dimensional and/or an immersive mode.

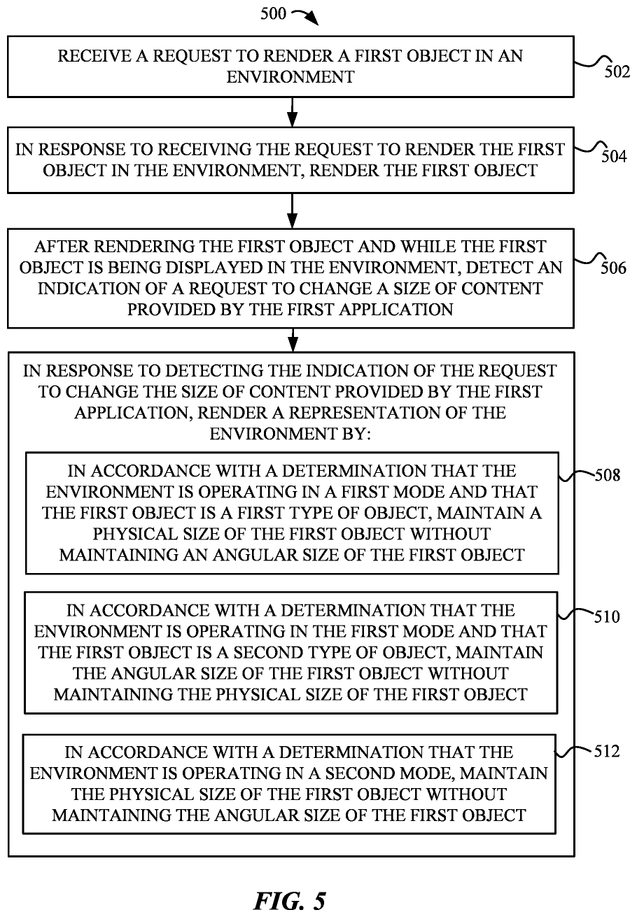

FIG. 5 is a flow diagram illustrating a method (e.g., method 500) for managing the size of virtual objects in accordance with some examples. Some operations in method 500 are, optionally, combined, the orders of some operations are, optionally, changed, and some operations are, optionally, omitted.

As described below, method 500 provides an intuitive way for managing the size of virtual objects. Method 500 reduces the cognitive burden on a user for managing an experience, thereby creating a more efficient human-machine interface. For battery-operated computing devices, enabling a user to manage the size of virtual objects faster and more efficiently conserves power and increases the time between battery charges.

In some examples, method 500 is performed by and/or at a system process (e.g., a daemon, a service, and/or other type of system process) (e.g., a process of an operating system) of a computer system (e.g., a device, a personal device, a user device, and/or a head-mounted display (HMD)). In some examples, the computer system is in communication with input/output devices, such as one or more cameras (e.g., a telephoto camera, a wide-angle camera, and/or an ultra-wide-angle camera), speakers, microphones, sensors (e.g., heart rate sensor, monitors, antennas (e.g., using Bluetooth and/or Wi-Fi), fitness tracking devices (e.g., a smart watch and/or a smart ring), and/or near-field communication sensors). In some examples, the computer system is in communication with a display generation component (e.g., a projector, a display, a display screen, a touch-sensitive display, and/or a transparent display).

At 502, the computer system receives, from a first application (e.g., a user application and/or an application installed on the computer system (e.g., by a user and/or another computer system)) (e.g., of the computer system), a request to render a first object (e.g., corresponding to the application) in an environment (e.g., multi-dimensional environment, such as a two-dimensional or a three-dimensional environment) (e.g., a virtual or a physical environment). In some examples, the computer system is a phone, a watch, a tablet, a fitness tracking device, a wearable device, a television, a multi-media device, an accessory, a speaker, and/or a personal computing device.

At 504, in response to receiving the request to render the first object in the environment, the computer system renders the first object.

At 506, after rendering the first object and while the first object is being displayed in the environment, the computer system detects an indication of (e.g., via one or more input devices (e.g., as described above)) (e.g., an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location) corresponding to, data corresponding to, and/or a call via one or more APIs) a request to change a size of content provided by the first application (e.g., a request to change a window size and/or a zoom size and/or a request to change a position of a view of the environment from a first position (e.g., a first location within the environment) to a second position (e.g., a second location within the environment) different from the first position).

In response to detecting the indication of the request to change the size of content provided by the first application, rendering a representation of the environment by: in accordance with (at 508) a determination that the environment is rendered according to (e.g., instructed to be displayed as being in and/or operating in, displayed in, and/or is in) a first mode (e.g., an application mode, such as a window mode and/or a mode that has greater restraints on size of objects than the second mode described below) and that the first object is a first type of object (e.g., a true scale object), wherein the environment corresponds to the first application and a second application different from the first application (and/or one or more other applications) while the environment is rendered according to the first mode, maintaining a physical size (e.g., in real world units) (e.g., within a predefined margin) of the first object without maintaining an angular size (e.g., relative to user's viewpoint) of the first object; in accordance with (at 510) a determination that the environment is rendered according to the first mode and that the first object is a second type of object (e.g., dynamically scale object) different from the first type of object, maintaining the angular size of the first object without maintaining the physical size of the first object; and in accordance with (at 512) a determination that the environment is rendered according to a second mode (e.g., an application mode, such as an immersive mode) (e.g., without respect to whether the first object is the first type of object or the second type of object), wherein the environment corresponds to the first application without corresponding to another application (e.g., another user application and the second application) (e.g., not including a system process and/or application) different from the first application (e.g., the environment includes one or more entities corresponding to the first application without including an entity corresponding to the other application) while the environment is rendered according to the second mode, maintaining the physical size of the first object without maintaining the angular size of the first object. In some examples, maintaining the physical size includes providing the physical size. In some examples, maintaining the angular size includes providing the angular size.

In some examples, the second mode is a window mode. In some examples, the first object is within a window (e.g., a two-dimensional or three-dimensional window) (e.g., a graphical user interface, an application window, a window suspended in space, a window that is surrounded by a three-dimensional environment, and/or a window that is displayed concurrently with one or more other windows) (e.g., a separate viewing area) while the environment is rendered according to the second mode.

In some examples, while a second object is being displayed in the environment, the computer system detects a second indication of (e.g., via one or more input devices (e.g., as described above)) (e.g., an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location) corresponding to, data corresponding to, and/or a call via one or more APIs) a request to change a size of content (e.g., provided by the first application (e.g., a request to change a window size and/or a zoom size and/or a request to change a position of a view of the environment from a first position (e.g., a first location within the environment) to a second position (e.g., a second location within the environment) different from the first position)), wherein the second indication is different from the indication. In some examples, the second object is provided by the first application. In some examples, the second indication is separate from the first indication. In some examples, in response to detecting the second indication of the request to change the size of content, the computer system renders a second representation (e.g., the representation and/or another representation) of the environment by: in accordance with a determination that the environment is rendered according to the second mode and that the second object is a third type of object (e.g., the first type of object or another type of object different from the first type of object), the computer system maintains a physical size (e.g., in real world units) (e.g., within a predefined margin) of the second object without maintaining an angular size (e.g., relative to user's viewpoint) of the second object. In some examples, maintaining the physical size of the second object includes sending (e.g., to the first application) the physical size of the second object, where the physical size of the second object does not change as the size of content is increased and/or decreased. In some examples, not maintaining the angular size of the second object includes sending (e.g., to the first application) the angular size of the second object, where the angular size of the second object changes as the size of content is increased and/or decreased; and in accordance with a determination that the environment is rendered according to the second mode and that the second object is a fourth type of object (e.g., the second type of object or another type of object different from the second type of object) different from the first type of object, the computer system maintains the angular size of the first object without maintaining the physical size of the first object, wherein the fourth type of object is different from the third type of object. In some examples, not maintaining the physical size of the second object includes sending the physical size of the second object, where the physical size of the second object does not change as the size of content is increased and/or decreased. In some examples, maintaining the angular size of the second object includes sending the angular size of the second object, where the angular size of the second object changes as the size of content is increased and/or decreased.

In some examples, while a third object is being displayed concurrently with the first object in the environment and in response to detecting the indication of the request to change the size of content provided by the first application, rendering the representation of the environment by: while maintaining the angular size of the first object (e.g., and in accordance with a determination that the environment is rendered according to the first mode and that the third object is the first type of object), maintaining a physical size (e.g., in real world units) (e.g., within a predefined margin) of the third object without maintaining an angular size (e.g., relative to user's viewpoint) of the third object; and while maintaining the physical size of the first object (e.g., and in accordance with a determination that the environment is rendered according to the first mode and that the second object is the second type of object), maintaining the angular size of the third object without maintaining the physical size of the third object. In some examples, while the third object is being displayed concurrently with the first object in the environment, in response to detecting the indication of the request to change the size of content provided by the first application, and in accordance with a determination that the environment is rendered according to the second mode, the computer system renders the representation of the environment by maintaining the angular size of the third object without maintaining the physical size of the third object.

In some examples, while a fourth object of a second application is being displayed concurrently with the first object in the environment and in response to detecting an indication of a request to change a size of content (e.g., provided by the first application and/or the second application), wherein the second application is different from the first application, the computer system renders the representation of the environment by: while maintaining the angular size of the first object (e.g., and in accordance with a determination that the environment is rendered according to the first mode and that the fourth object is the first type of object), the computer system maintains a physical size (e.g., in real world units) (e.g., within a predefined margin) of the fourth object without maintaining an angular size (e.g., relative to user's viewpoint) of the fourth object; and while maintaining the physical size of the first object (e.g., and in accordance with a determination that the environment is rendered according to the first mode and that the fourth object is the second type of object), the computer system maintains the angular size of the fourth object without maintaining the physical size of the fourth object.

In some examples, the content provided by the first application is concurrently displayed in the environment with content provided by the second application (e.g., while the environment is rendered according to the first mode and, in some examples, while the environment is not operating in the second mode).

In some examples, while the environment is rendered according to the first mode, the computer system detects a request (e.g., via one or more input devices (e.g., as described above)) (e.g., an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location) corresponding to, data corresponding to, and/or a call via one or more APIs) to transition to the second mode. In some examples, in response to detecting the request to transition to the second mode, the computer system causes the environment to operate in the second mode, wherein causing the environment to operate in the second mode includes removing, from the environment, content provided by another application different from the first application. In some examples, in response to detecting the request to transition to the second mode while and/or after maintaining the physical size of the first object without maintaining the angular size of the first object, the computer system continues to maintain the physical size of the first object without maintaining the angular size of the first object while the environment is rendered according to the second mode. In some examples, in response to detecting the request to transition to the second mode while and/or after maintaining the angular size of the first object without maintaining the physical size of the first object, the computer system continues to maintain the angular size of the first object without maintaining the physical size of the first object while the environment is rendered according to the second mode.

In some examples, while the environment is rendered according to the first mode: content corresponding to the first application is in a first area of the environment and not in a second area of the environment and content corresponding to a second application is in the first area and not in the second area, wherein the second area is different from the first area, and wherein the second application is different from the first application. In some examples, the second area is separate from and/or not surrounded by the first area, and the first area is separated from and/or not surrounded by the second area.

In some examples, while the environment is rendered according to the first mode and in accordance with a determination that a first set of one or more criteria is satisfied (e.g., that a current window corresponding to the first application is a three-dimensional bounded window), content provided by the first application is within a three-dimensional bounded window (e.g., a graphical user interface) (e.g., a separate viewing area). In some examples, content within a three-dimensional bounded window can move a distance in the x, y, and/or z directions, content within a three-dimensional bounded window can move a distance in each of the x, y, and z directions but is limited to moving a certain amount (e.g., non-zero) in each of the x, y, and/or z directions and/or within a three-dimensional bounded window is displayed with depth.

In some examples, while in the first mode and in accordance with a determination that a second set of one or more criteria is satisfied (e.g., that a current window corresponding to the first application is a two-dimensional bounded window), content corresponding to the first application is within a two-dimensional bounded window (e.g., a graphical user interface) (e.g., a separate viewing area). In some examples, the second set of one or more criteria is different from the first set of one or more criteria. In some examples, content within a two-dimensional bounded window can move a distance in the x and y directed but cannot move in the z direction, content within a three-dimensional bounded window can move a distance in each of the x and y directions but is limited to moving a certain amount (e.g., non-zero) in each of the x, y, and z directions (e.g., where content cannot move in the z direction), and/or within a three-dimensional bounded window is not displayed with depth.

In some examples, the first set of one or more criteria includes a criterion that is satisfied when a first window (e.g., the three-dimensional bounded window) corresponding to the first application includes a style (e.g., a setting, an option, a property, and/or data included in data of the first window) defining that the window is a three-dimensional bounded window. In some examples, the second set of one or more criteria includes a criterion that is satisfied when a second window (e.g., the two-dimensional bounded window) corresponding to the first application includes a style defining that the second window is a two-dimensional bounded window.

In some examples, the second area surrounds the first area. In some examples, the first area surrounds the second area.

In some examples, maintaining the physical size of the first object without maintaining the angular size of the first object includes, at a first time while the size of content provided by the first object is changed, maintaining the physical size of the first object and maintaining the angular size of the first object.

In some examples, maintaining the physical size of the first object without maintaining the angular size of the first object includes: at a second time, different from the first time, while the size of content provided by the first object is changed, changing the angular size of the first object while maintaining the physical size of the first object. In some examples, maintaining the angular size of the first object without maintaining the physical size of the first object includes: at a third time while the size of content provided by the first object is changed maintaining the physical size of the first object and maintaining the angular size of the first object; and at a fourth time, different from the third time, while the size of content provided by the first object is changed, changing the physical size of the first object while maintaining the angular size of the first object.

Note that details of the processes described above with respect to method 500 (e.g., FIG. 5) are also applicable in an analogous manner to other methods described herein. For example, method 700 optionally includes one or more of the characteristics of the various methods described above with reference to method 500. For example, the size of virtual objects can be managed using one or more steps of method 500 while a location of a user can be determined using one or more steps of method 700 for the same experience and/or at the same time. For brevity, these details are not repeated below.

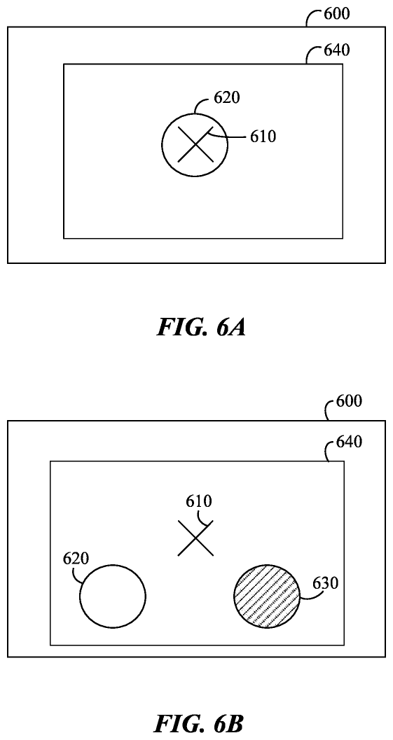

FIGS. 6A-6B are exemplary user interfaces for managing an experience that is attended by one or more users. The user interfaces of FIGS. 6A-6B are used to illustrate the processes described below, including the processes of FIG. 7.

FIG. 6A illustrates display area 600 including origin 610 (e.g., the “X”) and person 620. Origin 610 is the origin (e.g., the center, the meeting point, the target area, and/or the performing place) for experience 640. In some examples, an experience includes a meeting, game, an event, and/or a conference that is executing in a virtual environment. In some examples, the origin for an experience is the focal point of the experience, such as bowling position at a bowling alley, a stage at a concert, the podium at a conference, and/or the batter's box at a baseball game. It should be understood that display area 600 is a display area a computer system, such as an HMD and/or smart glasses. In some examples, the display area is a display generation component, such as a touch sensitive display, a translucent display, and/or a display screen. In some examples, the computer system includes one or more components as those discussed above in relation to devices 105, 110, and/or 300.

At FIG. 6A, the display area includes an indication that person 620 is located at the origin. Before FIG. 6A, a determination was made that only person 620 (or less than a number of people) would be attending experience 640 at a particular point in time. Thus, because this determination was made, person 620 is located at the origin in FIG. 6A. In some examples, the determination was made at a time that experience 640 was launched and/or one or a user interface corresponding experience 640 was initially displayed in the virtual environment. In some examples, the experience represented in FIGS. 6A-6B was launched from another experience in the virtual environment that included person 620 or person 630 of FIG. 6B.

FIG. 6B illustrates display area 600 including person 620 and person 630 placed at location outside of origin 610. Here, person 620 and person 630 are placed outside of the origin based on a determination that more than a threshold number of people will be attending the experience. In some examples, the determination was made at a time that experience 640 was launch and/or a user interface corresponding experience 640 was displayed in the virtual environment.

FIG. 7 is a flow diagram illustrating a method (e.g., method 700) for managing an experience in accordance with some examples. Some operations in method 700 are, optionally, combined, the orders of some operations are, optionally, changed, and some operations are, optionally, omitted.

As described below, method 700 provides an intuitive way for managing an experience. Method 700 reduces the cognitive burden on a user for managing an experience, thereby creating a more efficient human-machine interface. For battery-operated computing devices, enabling a user to manage an experience faster and more efficiently conserves power and increases the time between battery charges.

At 702, the computer system sends, from an application (e.g., the application described above with respect to method 700) (and, in some examples, via an application programming interface (API)), a request for a pose (e.g., from the 610 relative to 620 and 630) (e.g., a location and/or an orientation) associated with (and/or corresponding to) a user (e.g., a person being tracked by the application and/or the computer system) with respect to an origin (e.g., 610) (e.g., a coordinate location, a middle, a center, and/or a designed origin) of an experience (e.g., 640) (e.g., a game, a central experience, and/or meeting point (e.g., socializing point and/or origin), and/or a currently viewable portion) for the application.

At 704, after (e.g., as a response to) sending the request for the pose associated with the user with respect to the origin of the experience for the application and in accordance with a determination that a first number of users (e.g., one or, in some examples, more than one) are in the experience (e.g., a non-shared experience and/or an individual experience) for the application, the computer system receives (e.g., via the API) a first pose (e.g., as described above in relation to FIG. 6A).

At 706, after sending the request for the pose associated with the user with respect to the origin of the experience for the application and in accordance with the determination that the first number of users are in the experience for the application, the computer system renders the experience for the application based on (e.g., from, in a pose that is the same as, opposite of, and/or adjusted using and/or from) the first pose (e.g., as described above in relation to FIG. 6A).

At 708, after sending the request for the pose associated with the user with respect to the origin of the experience for the application and in accordance with a determination that a second number of users (e.g., more than one or, in some examples, one) are in the experience (e.g., a shared experience and/or an experience involving a plurality of users) for the application, the computer system receives (e.g., via the API) a second pose different from the first pose (e.g., as described above in relation to FIG. 6B).

At 710, after sending the request for the pose associated with the user with respect to the origin of the experience for the application and in accordance with a determination that a second number of users (e.g., more than one or, in some examples, one) are in the experience (e.g., a shared experience and/or an experience involving a plurality of users) for the application, the computer system renders the experience for the application based on (e.g., from, in a pose that is the same as, opposite of, and/or adjusted using and/or from) the second pose e.g., as described above in relation to FIG. 6B). In some examples, after sending the request for the pose associated with the user with respect to the origin of the experience for the application and in accordance with a determination that the second number of users are in the experience for the application, the computer system does not receive the first pose. In some examples, after sending the request for the pose associated with the user with respect to the origin of the experience for the application and in accordance with a determination that the second number of users are in the experience for the application, the computer system does not render the experience for the application based on the first pose. In some examples, after sending the request for the pose associated with the user with respect to the origin of the experience for the application and in accordance with a determination that the first number of users are in the experience for the application, the computer system does not receive the second pose. In some examples, after sending the request for the pose associated with the user with respect to the origin of the experience for the application and in accordance with a determination that the first number of users are in the experience for the application, the computer system does not render the experience of the application based on the second pose.

In some examples, the first number of users is one. In some examples, the first pose corresponds to a center (e.g., a center of origin) of the experience for the application. In some examples, the second number of users is two or more. In some examples, the second pose corresponds to an offset greater than zero from the center of the experience for the application. In some examples, rendering the experience for the application based on the first pose includes rendering the experience from a perspective located at the center of the experience for the application. In some examples, rendering the experience for the application based on the second pose includes rendering the experience from a perspective located at the offset from the center of the experience for the application.

In some examples, after (e.g., as a response to and/or in response to) sending the request for the pose associated with the user with respect to the origin of the experience for the application and in accordance with a determination that a third number of users (e.g., more than two) are in the experience for the application, wherein the third number of users is different from the first number of users and the second number of users, the computer system receives (e.g., via the API) a third pose different from the first pose and the second pose. In some examples, after (e.g., as a response to and/or in response to) sending the request for the pose associated with the user with respect to the origin of the experience for the application and in accordance with a determination that a third number of users (e.g., more than two) are in the experience for the application, wherein the third number of users is different from the first number of users and the second number of users, the computer system renders the experience for the application based on the third pose.

In some examples, the second pose is generated based on a plurality of users being placed around an origin (e.g., a center and/or center of origin) of the experience for the application. In some examples, placing the plurality of users around the origin includes not placing a user at the origin.

In some examples, the second pose is generated based on multiple users being placed in a sequence (e.g., each user next to and/or adjacent to another user and/or each user in a line, circle, and/or other geometric pattern) near (e.g., around, a non-zero distance away from, and/or within a predefined distance from) a second origin (e.g., a center) of the experience for the application. In some examples, placing the plurality of users in the sequence near the origin includes not placing a user at the origin.

In some examples, the request for the pose is sent in response to detecting intent of a user to launch (e.g., initiate and/or start) the application (and/or detecting launch of the application and/or detecting a request to launch the application and/or before detecting the request to launch the application).

In some examples, after (and/or while) detecting intent of the user to launch the application in a respective mode (e.g., the second mode as described above with respect to method 500), a process of a computer system executing the application performs one or more pre-launch tasks (e.g., causing one or more processes (e.g., non-essential processes) to shut down and/or cease executing) (e.g., configuring one or more states and/or modes of the computer system (e.g., an immersion state and/or the second mode) and/or transitioning the computer system from operating in the first mode, as described above with respect to method 500, to operating in the second mode, as described above with respect to method 500) on behalf of the application. In some examples, the one or more pre-launch tasks correspond to the application launching in the respective mode. In some examples, the one or more pre-launch tasks occur before an input is detected to launch the application in the respective mode. In some examples, detecting the intent of the user includes detecting that a user is going to and/or is likely going to send a request (e.g., moving gaze towards a button, starting to issue a voice command, starting to perform one or more air gestures, and/or moving towards a virtual object corresponding to the application) to launch the application (e.g., within a predetermined period of time (e.g., 1-60 seconds)).

In some examples, the request for the pose is sent in conjunction with a request to change from a second experience to the experience (e.g., while participating in the second experience) (e.g., going from the second experience to the experience) (e.g., going from virtual a conference room to a virtual bowling game). In some examples, the second experience is for the application. In some examples, the second experience is different from the experience.

In some examples, the first pose includes a first displacement (e.g., zero or more units of distance) from a third origin (e.g., a center and/or center of origin) of the experience. In some examples, the second pose includes a second displacement (e.g., zero or more units of distance) from the third origin of the experience. In some examples, the second displacement is different from (e.g., more than and/or less than) the first displacement.

In some examples, the request for the pose includes an indication of a coordinate space (e.g., a type of coordinate space, such as relative to a viewpoint, a location in an environment, and/or a fourth origin of the experience). In some examples, the request for the pose includes a request to identify a coordinate space.

In some examples, in accordance with a determination that the request for the pose includes an indication of a first coordinate space (e.g., a type of coordinate space, such as relative to a viewpoint, a location in an environment, and/or a fourth origin of the experience), a respective pose (e.g., the first pose and/or the second pose) that is received corresponds to the first coordinate space (e.g., a cartesian and/or a Polar coordinate system). In some examples, in accordance with a determination that the request for the pose includes an indication of a second coordinate space (e.g., a cartesian and/or a Polar coordinate system) different from the first coordinate space, the respective pose that is received corresponds to the second coordinate space.

In some examples, after receiving the first pose, the computer system sends a second request for the pose associated with the user (e.g., with respect to the origin of the experience for the application). In some examples, after sending the second request for the pose associated with the user, the computer system receives one or more affine transformations instead of a pose, wherein the one or more affine transformations correspond to a previous pose (e.g., the first pose, the second pose, or another pose different from the first pose and the second pose) received by the application. In some examples, the one or more affine transformations are received instead and/or in lieu of the first pose.

Note that details of the processes described above with respect to method 700 (e.g., FIG. 7) are also applicable in an analogous manner to the methods described herein. For example, method 500 optionally includes one or more of the characteristics of the various methods described above with reference to method 700. For brevity, these details are not repeated below.

Applications in mixed reality operating systems have scenes that have an extent in the physical space around the user. In some examples, two-dimensional framework measures sizes in points. In some examples, in mixed reality Operating System 1.0, certain kinds of scenes are scaled dynamically depending on where the user places them in the environment, causing points' physical length to increase or decrease accordingly. There are many use cases for letting an application express certain lengths in real-world units: to display UI that is size-invariant, to initially size volumetric windows, to ensure certain UI elements can be replaced if they would be too small to see, to overlay 3D UI on the outside world, and so on. We propose API for these use cases.

The new API entry points provided cover the following: Scene sizing: Scenes whose content should match real-world measurements can specify their default size in those measurements, rather than points. This provides guidance to the system as to how to scale and size them on first appearance. (This is the only entry point that takes real-world measurements instead of points.) Points-length conversions for arbitrary values: Since the points-per-meter value depends on the particular scene (both its type and in some cases its positioning), the conversion machinery ties into the two-dimensional framework view update system and is only available from inside a View's implementation. These API introduce the assumption that points and physical sizes can relate in well-defined, device-detectable ways. The variety of output mechanisms of devices running other operating systems makes it fraught to make the same guarantee outside of mixed reality operating system. In some examples, the API is available on mixed reality operating system.

The following definitions make use of the UnitLength type vended by the Foundation framework. The following modifiers are added as an extension to Scene. The documentation comment is written once, but in the final result it will be repeated, appropriately slightly edited, for each new variant.

```
  ‘‘‘swift
  @available(phone operating systems, unavailable)
  @available(computer operating system, unavailable)
  @available(media operating system, unavailable)
  @available(wearable operating system , unavailable)
  @available(mixed reality operating system 1.0, *)
  extension Scene {
    /// Sets a default width and height for a window with an extent in space.
    ///
    /// Use this scene modifier to indicate a default initial size for a new
    /// window that the system creates from a “Scene“ declaration. For
    /// example, a user can request that new windows that a “WindowGroup“
    /// generates occupy 30 cm in the x-dimension and 60 cm in
    /// the y-dimension:
    ///
    /// @main
    /// struct MyApp: App {
    /// var body: some Scene {
    /// WindowGroup {
    /// ContentView( )
    /// }
    /// .windowStyle(.volumetric)
    /// .defaultSize(width: 0.3, height: 0.6, in: .meters)
    /// }
    /// }
    ///
    /// The size that a user species acts only as a default for when the window
    /// first appears. If appropriate, users can later resize the window using
    /// interface controls that the system provides. Also, during state restoration,
    /// the system restores windows to their most recent size rather than
    /// the default size.
    ///
    /// In some examples, of a user specifies a default size that's outside the range of the
window's
    /// inherent resizability in one or both dimensions, the system clamps the
    /// affected dimension to keep it in range. A user can configure the
    /// resizability of a scene using the “Scene/windowResizability(_:)“
    /// modifier.
    ///
    /// In some examples, this default size modifier affects any scene type whose
window style is
    /// “WindowStyle/volumetric“. It has no effect on non-volumetric scenes.
    ///
    /// If a user wants to specify the size input in terms of a size instance,
    /// use “Scene/defaultSize(_:)“ instead.
    ///
    /// - Parameter width: The default width for windows created from a scene.
    /// - Parameter height: The default height for windows created from a scene.
    /// - Parameter unit: The measurement unit of physical extent that ‘width‘ and
    /// ‘height‘ are specified in.
    ///
    /// - Returns: A scene that uses a default size for new windows.
    public func defaultSize(
      width: CGFloat,
      height: CGFloat,
      depth: CGFloat,
      in unit: UnitLength) −> some Scene
    /// Same doc comment as above, with minor appropriate edits.
    public func defaultSize(
        _ size: Size3D,
      in unit: UnitLength) −> some Scene
  }
  ‘‘‘
```

In some examples, a modifier request that a window start with the specified width, height and depth. In some examples, in mixed reality operating system 1.0, this modifier is respected for scenes that respect the .volumetric window style. For example:

```
‘‘‘swift
struct MyAquariumApp: App {
  var body: some Scene {
    WindowGroup(id: ″aquarium″) {
      FishTankView( )
    }
    .windowStyle(.volumetric)
    .defaultSize(width: 0.9, height: 0.45, depth: 0.4, in: .meters)
  }
}
‘‘‘
```

This requests that the volume be of 90 cm by 45 cm by 40 cm. In some examples, since volumetric scenes are statically sized in mixed reality operating system 1.0, this also sets the scene's size for the whole of the application lifetime.

Two APIs are proposed: a conversion type that can be accessed in the environment, and a convenience type that simplifies use in the case of constant real-world length values.

```
  ‘‘‘swift
  extension EnvironmentValues {
    /// The physical metrics associated with a scene.
    ///
    /// Reading this value returns a ‘PhysicalMetricsConverter‘ corresponding
    /// to the window scene associated with the environment's reader. In some
examples, the
    /// converter can convert point sizes into physical measurements of length,
    /// and vice versa.
    ///
    /// In some examples, reading this value is supported in the body of a “View“ or of
    /// a type that inherits a “View“'s environment.
    @available(phone operating system, unavailable)
    @available(computer operating system, unavailable)
    @available(media operating system, unavailable)
    @available(wearable operating system , unavailable)
    @available(mixed reality operating system 1.0, *)
    public var physicalMetrics: PhysicalMetricsConverter { get }
  }
  /// In some examples, a physical metrics converter provides conversion between point
values and
  /// their extent in 3D space, in the form of physical length measurements.
  ///
  /// In some examples, converters are available from the environment of a ‘View‘ or
other type that
  /// inherits a ‘View‘'s environments, and are associated with the scene that
  /// contains that environment. The conversions expect (or emit) values in points
  /// in that scene's coordinate system, and convert these to (or from) measurements
  /// of length in the user's reference frame. For example, if the scene is
  /// scaled, that scale will be taken into account.
  ///
  /// To obtain a converter, use the “EnvironmentValues/physicalMetrics“ key:
  ///
  /// ‘‘‘swift
  /// struct MyView: View {
  /// @Environment(\.physicalMetrics) var physicalMetrics
  /// ...
  /// }
  /// ‘‘‘
  ///
  /// In some examples, when user action modifies a scene so that measurements have
changed (e.g., by
  /// changing its scale), the view that accessed that environment key and its hierarchy
  /// will be reevaluated.
  ///
  /// Attempting to obtain a converter inside a type not associated with a scene's
  /// contents (for example, from an “App“ or “Scene“'s environment) is not
  /// supported.
  @available(phone operating system, unavailable)
  @available(computer operating system, unavailable)
  @available(media operating system, unavailable)
  @available(wearable operating system, unavailable)
  @available(mixed reality operating system 1.0, *)
  public struct PhysicalMetricsConverter {
    /// Converts a vector of physical length measurements, in the specified unit,
    /// to a vector of values in points suitable for use in the environment this
    /// converter is associated with.
    ///
    /// - Parameters:
    /// - ‘lengths‘: A vector of physical measurements of length
    /// - ‘unit‘: The unit of measure for the lengths
    /// - Returns: A value in points. Use this value only in the scene this
    /// converter was associated with.
    public func convert<V>(_ lengthValues: V, from unit: UnitLength) −> V where V :
VectorArithmetic
    /// Converts a vector of values in points to corresponding physical length
    /// measurements in the specified unit,
    ///
    /// In some examples, the point values are in the coordinate system of the scene
    /// that this converter is associated with. In some examples, if the scene is scaled,
the
    /// physical measurement will take this scale into account.
    ///
    /// - Parameters:
    /// - ‘points‘: A vector of values in points in the associated scene's
    /// coordinate system
    /// - ‘unit‘: The unit of measure for the returned lengths
    /// - Returns: A vector of physical length measurements, each converted from the
    /// points value in the input vector at the same position.
    /// converter was associated with.
    public func convert<V>(_ pointValues: V, to unit: UnitLength) −> V where V :
VectorArithmetic
    /// Same doc comment, with appropriate minor edits, for all the following:
    public func convert(_ point: Point3D, from unit: UnitLength) −> Point3D
    public func convert(_ point: Point3D, to unit: UnitLength) −> Point3D
    public func convert(_ size: Size3D, from unit: UnitLength) −> Size3D
    public func convert(_ size: Size3D, to unit: UnitLength) −> Size3D
    public func convert(_ rect: Rect3D, from unit: UnitLength) −> Rect3D
    public func convert(_ rect: Rect3D, to unit: UnitLength) −> Rect3D
    public func convert(_ point: CGPoint, from unit: UnitLength) −> CGPoint
    public func convert(_ point: CGPoint, to unit: UnitLength) −> CGPoint
    public func convert(_ size: CGSize, from unit: UnitLength) −> CGSize
    public func convert(_ size: CGSize, to unit: UnitLength) −> CGSize
    public func convert(_ rect: CGRect, from unit: UnitLength) −> CGRect
    public func convert(_ rect: CGRect, to unit: UnitLength) −> CGRect
    public func convert(_ lengthValue: CGFloat, from unit: UnitLength) −> CGFloat
    public func convert(_ pointsValue: CGFloat, to unit: UnitLength) −> CGFloat
  }
  ‘‘‘The PhysicalMetricsConverter type provides points-to-lengths conversions, and
vice versa, for several types. There are no public constructors for this type. It is accessed from
the environment using the \.physicalMetrics key:
  ‘‘‘
  struct RulerView: View {
    @Environment(\.physicalMetrics) var metrics: PhysicalMetricsConverter
    let size: CGFloat
    var lengthInPoints: CGFloat {
        metrics.convert(size, from: .meters)
    }
  }
  ‘‘‘
```

Using this environment key outside of a View that is in a view hierarchy is not supported; see below. In some examples, implementations that perform a conversion will form a dependency on the scene's points-per-meter value, and will be reevaluated as the points-per-meter for a scene changes (for example, a 2.5D window being repositioned by the user). Using this environment key outside of a View that is in a view hierarchy is not supported; see below. In some examples, implementations that perform a conversion will form a dependency on the scene's points-per-meter value, and will be reevaluated as the points-per-meter for a scene changes (for example, a 2.5D window being repositioned by the user).

In some examples, if a view makes use of fixed real-world length measurements, it can define a name for them using the PhysicalMetric type. This is similar to the existing ScaledMetric type already in two-dimensional framework; unlike that type. In some examples, the metric isn't scaled from points to points, but from a real-world measurement to points.

```
  ‘‘‘swift
  /// Provides access to a value in points that corresponds to the specified
  /// physical measurement.
  ///
  /// Use this property wrapper inside a “View“ or a type that inherits a ‘View‘'s
  /// environment, like a “ViewModifier“. Its value will be the equivalent in points
  /// of the physical measurement of length you specify.
  ///
  /// For example, to have a variable that contains the amount of points corresponding
  /// to one meter, you can do the following:
  ///
  /// ‘‘‘swift
  /// struct MyView: View {
  /// @PhysicalMetric(1.0, in: .meters) var oneMeter
  /// ...
  /// }
  /// ‘‘‘
  ///
  /// Using this wrapper for a property of a type not associated with a scene's view
  /// contents, like an “App“ or a “Scene“, is unsupported.
  @available(phone operating system, unavailable)
  @available(computer operating system, unavailable)
  @available(media operating system, unavailable)
  @available(wearable operating system, unavailable)
  @available(mixed reality operating system 1.0, *)
  @propertyWrapper
  public struct PhysicalMetric<Value> {
    /// A value in points in the coordinate system of the associated scene.
    public var wrappedValue: Value { get }
    /// Creates a value that maps the specified single physical length measurement,
    /// in the specified unit, to the corresponding value in points in the
    /// associated scene.
    public init(_ value: CGFloat, in unit: UnitLength) where Value == CGFloat
    /// Same doc comment as above, with minor corresponding edits, for:
    public init(wrappedValue value: Value, from unit: UnitLength) where Value :
VectorArithmetic
    public init(wrappedValue point: CGPoint, from unit: UnitLength) where Value ==
CGPoint
    public init(wrappedValue size: CGSize, from unit: UnitLength) where Value ==
CGSize
    public init(wrappedValue rect: CGRect, from unit: UnitLength) where Value ==
CGRect
    public init(wrappedValue point: Point3D, from unit: UnitLength) where Value ==
Point3D
    public init(wrappedValue size: Size3D, from unit: UnitLength) where Value ==
Size3D
    public init(wrappedValue rect: Rect3D, from unit: UnitLength) where Value ==
Rect3D
  }
  For example:
  ‘‘‘swift
  struct PhysicalChessboardView: View {
    @PhysicalMetric(from: .inches)
    var singleChessboardSquareSide = 2.5
    @PhysicalMetric(from: .inches)
    var fullChessboardAndWoodenBorderSize = CGSize(width: 22, height: 22)
    ...
  }
  ‘‘‘
  ‘‘‘
```

In some examples, the values of these properties will be in points, and will match the given physical lengths provided. In some examples, if the points-per-meter value of a dynamically scaled scene changes, the view using this property wrapper will be invalidated. Using this environment key outside of a View that is in a view hierarchy is not supported; see below.

In some examples, both PhysicalMetric and PhysicalMetricsConverter require the context of a connected scene to obtain the correct points-per-meter ratio. These types are accessible in contexts that do not have that information. Namely: Some of these contexts, like a Scene or App struct, are inherently incorrect. In View s, this information is accessible when the content is being hosted in the view hierarchy. In some examples, these APIs are documented as not supported outside of a View. We leave what this means to be implementation-defined, but not all these situations are detectable or avoidable. In practice: If we detect definite improper usage (e.g., outside a View), we reserve the right to produce a precondition failure on detection. If we detect usage that is proper, but in an improper context (e.g., a View not hosted in the view hierarchy), we reserve the right to alert the user by producing a fault in the Xcode runtime issues log. In these cases, we will use a default or hardcoded points-per-meter ratio. This signs us up for continually improving our logic so that we do not produce false positives.

These changes are additive and do not impact existing code. The PhysicalMetricsConverter type provides a basic operation; any further directions will depend on feedback, and will likely concentrate in the area of further improvements to scene sizing or additional conveniences.

All of the names above have several alternatives that can be explored in review. Support for initial sizing (defaultSize) with physical metrics for 2.5D windows has been deferred to a later release. We plan to use linked-on-or-after checks in those versions of the OS to not interfere with the current semantics, which do nothing to anything except for volumetric scenes. We could provide a raw points-Per-Meter value through the environment, as we do as a SPI. I believe this would make the use sites less readable, by requiring explicit math at each site with the possibility of type confusion between values that are meant to be in real-world lengths and values that are meant to be in points. In the current design, despite using the convenience of existing points-based types, every single real-world measurement is accompanied visually by an adjacent in: UnitLength parameter, so that it is clear at the call site that the particular value is not in points.

We could not provide any access to lengths at all. This would hamper several use cases; for example, it could cause developers to hardcode our current rules for point sizing in statically sized volumetric scenes, which we want to avoid. Dynamic interfaces to these values allow us to design different kinds of scene behaviors for future XR use cases without invalidating the assumptions of existing view code. PhysicalMetric is provided as a convenience; it can be replaced by advising use of PhysicalMetricsConverter instead. In a previous version of this draft, PhysicalMetric and PhysicalMetricsConverter were simply not available to use in types not associated with a scene's view contents. However, making the return types optional was ruled out as unergonomic. This may make code like the following legal to write and compile, but incorrect:

```
‘‘‘swift
struct MyVolumetricApp: App {
  @PhysicalMetric(from: .meters)
  var oneMeter = 1
  var body: some Scene {
    WindowGroup {
      MyVolumeView( )
    }
    .windowStyle(.volumetric)
    .defaultSize(width: oneMeter, height: oneMeter, depth: oneMeter)
  }
}
‘‘‘
```

If this code worked, it might have seemed reasonable. If we are able to detect this case, we may fire a precondition failure; see above.

Just as a window scene creates space for a 2D application to exist, a volumetric scene creates space for a 3D application. One example use for a volumetric scene is for a future iteration of the Maps application. Most people typically use Maps in its 2D view, looking directly down onto the map. On existing platforms, they can then put Maps into a 3D view, where the camera pans down, and the map seems to come to life: detailed models of the buildings rise out of the ground, letting people explore cities in a new way. Mixed reality operating system, being an inherently 3D platform, is a natural fit to extend this functionality: this 3D map would render as if it were a table-sized model, in front of you. To get a different perspective on it, you simply move around it, letting you peek behind buildings and peer down from above. On mixed reality operating system, 3D content can already be displayed within existing windows, but this content is not treated any differently from a typical 2.5D application window. One immediately obvious difference is in scale. Application windows, in order to keep text and UI legible, appear on the platform with a consistent angular size, meaning no matter how close or far away the window is, it will always occupy the same amount of your field of vision. A window could appear to be size of your computer monitor just in front of you, or the size of a billboard, several hundred feet away. This makes sense for most applications in order to preserve their usability, but is incongruous when attempting to represent things that more closely mirror real life. A 3D Chess game, for example, should not suddenly dwarf the table it's on when you move it across the room. As such, a volumetric scene confers both qualitative differences at the app level (this is a new class of app which is fundamentally built for 3D, rather than being adapted from the existing world of fundamentally 2D software), as well as quantitative differences in how the system presents these apps (applying a different scaling technique, a different set of visual effects, and a different style of chrome).

A developer specifies that a Window, WindowGroup, or DocumentGroup is Volumetric with a new window style:

```
‘‘‘swift
struct ChessApp: App {
  var body: some Scene {
    WindowGroup(id: ″chessboard″) {
      View{ ... }
    }
    .windowStyle(.volumetric)
  }
}
‘‘‘
```

By applying this window style to any existing window type, the backing UIWindowScene gets created in the system shell with new volumetric state and associated behaviors. Volumetric scenes in v1 support static sizing, composing with the defaultSize( ) modifier:

```
‘‘‘swift
WindowGroup( ) { ... }
  .windowStyle(.volumetric)
  .defaultSize(width:400, height:400, depth:400)
‘‘‘
```

If the developer does not supply a size with this modifier, the system will apply a standard default size for a volumetric window, to be determined by HI. A volumetric scene can also be requested via the same openWindow environment property that developers are used to:

```
‘‘‘swift
struct WindowView: View {
  @Environment(\.openWindow) private var openWindow
  var body: some View {
    Button(″Play Chess!″) {
      openWindow(″chessboard″)
    }
  }
}
‘‘‘
```

When a volumetric scene is opened, its placement is handled by the system shell. There is no specific attempt to place the scene on the floor or other horizontal surface, and the scene is infinitely repositionable by the user without any sort of snapping behavior to real-world objects.

While intended to host 3D content, usually created with three-dimensional kit and hosted in a View, most 2D user interface elements can still be used. Like the 3D content, the 2D UI will also draw in true scale, which could impact interactability depending on its distance from the user. This is a limitation for v1, and something we plan to address in the future; see “Mixed Scale” under Future Directions for details. Views laid out in the volumetric scene are centered on the X and Y axes by default, flowing vertically like in a 2D application. They occupy what is effectively the vertical plane of the scene's space, offset from the back of the volume by a fixed amount. These views can be repositioned arbitrarily using standard two-dimensional framework layout API, including the 3D layout extensions added for mixed reality operating system which are out of the scope of this proposal. Sheets and modal presentations require special consideration. In typical 2.5D applications, presenting a modal sheet displaces the main app window backward, with the sheet coming up in front. If multiple modals are presented, this appears as a stack, with the most recent modal on top. For volumetric scenes, this displacement behavior makes less sense: because the framework is not aware of the direction the user is relative to the scene (their “cardinality” relative to the scene), modals cannot be shown on the user-facing side, the way that chrome does. Displacement also makes less sense for volumetric content than it does for a floating platter window. Because of these limitations, the current plan is to not allow developers to present modal sheets in volumetric apps. An exception will be made for specific system UI such as Game Center and Apple Pay, where we can more precisely control its content and appearance.

Phone applications have their origin in the top-left corner of the app, with the X axis running horizontally to the right, and the Y axis vertically downward. This same convention is used for platter-style applications on mixed reality operating system. Volumetric applications extend this naturally by putting the origin at the top-left-back corner of the box, relative to the user. The X axis projects to the user's right, the Y axis toward the floor, and the Z axis outward toward the user. Developers work in points when laying out content in applications. On 2D systems, a point is a pixel-agnostic unit of linear measure, with its origins in physical printing. Because our devices have high-DPI screens of varying pixel densities, working in points is a useful abstraction for expressing the size of onscreen content. The exact ratio of a point to a pixel varies based on display zoom and pixel density, but is generally around a 2:1 to 3:1 scale. N301 presents a new model where application content is entirely divorced from the pixel-representation on screen, instead representing some factor of real distance. For dynamic scale applications, a point is the distance of 1 millimeter at one meter away from the eye, representing a specific amount of angular space. The exact points-per-meter value is calculated during initial scene creation and placement, and then updated after each repositioning of the window. Developers should not need to concern themselves with this, letting them define content in terms of points as they are already used to, and knowing the content will be functional at any distance away. For true scale, a point is equal to 1 millimeter. See “Future Considerations” for discussion on accepting real-world measures.

The creation of all scenes on phoneOS-derived platforms is governed by the system shell. The core of the mechanical changes for volumetric scenes are all applied at the system shell level. During scene creation, the shell picks up the volumetric scene request and applies the following changes: Volumetric scenes get true scale, not dynamic scale, Volumetric scenes get user-facing chrome, which changes side based on the user's position, and Volumetric scenes do not fade out when viewed from angles other than the front.

Because UIKit's means of exposing this type is through a new scene session role, UISceneSession.Role.windowApplication Volumetric, two-dimensional framework developers will also be able to see this value by using a UIApplicationDelegateAdaptor, allowing for unique scene customization from their scene delegate callbacks.

```
Add VolumetricWindowStyle.swift:
‘‘‘swift
/// A window style which creates a 3D volumetric window.
///
/// Use “WindowStyle/volumetric“ to construct this style.
@available(phoneOS, unavailable)
@available(computerOS, unavailable)
@available(wearableOS, unavailable)
@available(mediaOS,unavailable)
@available(mixed reality operating system 1.0, *)
public struct VolumetricWindowStyle: WindowStyle {
  // Implementation is package internal
}
@available(phoneOS, unavailable)
@available(computerOS, unavailable)
@available(wearableOS, unavailable)
@available(mediaOS,unavailable)
@available(mixed reality operating system 1.0, *)
extension WindowStyle where Self == VolumetricWindowStyle {
  /// A window style which creates a 3D volumetric window.
  ///
  /// Volumetric windows are intended to host 3D content within a bounded
  /// region. Content in this region will get true scale by default, and allows
  /// the user to view the content from all angles without the scene contents
  /// fading out. Volumetric scenes are intended for contained content and
  /// should not be used for immersive environments.
  public static var volumetric: VolumetricWindowStyle { get }
}
‘‘‘
```

Mark existing DefaultWindowStyle and .automatic option available. On mixed reality operating system it resolves to the typical 2.5D “platter” app style. Internally, this relates to the PlatterWindowStyle SPI. We are working with marketing to determine the final name for this type of app window, and exposing a concrete WindowStyle here will come in a separate addendum proposal once that name is finalized.

```
‘‘‘swift
@available(phoneOS, unavailable)
@available(computerOS 11.0, *)
@available(mediaOS, unavailable)
@available(wearableOS, unavailable)
@available(mixed reality operating system 1.0, *)
extension WindowStyle where Self == DefaultWindowStyle {
  /// The default window style.
  public static var automatic: DefaultWindowStyle { get }
}
/// The default window style.
///
/// You can also use “WindowStyle/automatic“ to construct this style.
@available(phoneOS, unavailable)
@available(computerOS 11.0, *)
@available(mediaOS, unavailable)
@available(wearableOS, unavailable)
@available(mixed reality operating system 1.0, *)
public struct DefaultWindowStyle: WindowStyle {
  public init( ) {...}
}
‘‘‘ Mark WindowStyle as available on mixed reality operating system:
‘‘‘swift
@available(phoneOS, unavailable)
@available(computerOS 11.0, *)
@available(mediaOS, unavailable)
@available(wearableOS, unavailable)
@available(mixed reality operating system 1.0, *)
public protocol WindowStyle {...}
@available(phoneOS, unavailable)
@available(computerOS 11.0, *)
@available(mediaOS, unavailable)
@available(wearableOS, unavailable)
@available(mixed reality operating system 1.0, *)
extension Scene {
  /// Sets the style for windows created by this scene.
  public func windowStyle<S: WindowStyle>(_ style: S)
  −> some Scene {...}
}
‘‘‘Volumetric windows support static sizing with the defaultSize modifier:
‘‘‘swift
@available(phoneOS, unavailable)
@available(computerOS, unavailable)
@available(wearableOS, unavailable)
@available(mediaOS,unavailable)
@available(mixed reality operating system 1.0, *)
extension Scene {
  /// Sets a default size for a volumetric window.
  ///
  /// Use this modifier to indicate the default initial size for a new 3D
  /// window created from a “Scene“ using “VolumetricWindowStyle“:
  ///
  /// WindowGroup {
  /// ContentView( )
  /// }
  /// .windowStyle(.volumetric)
  /// .defaultSize(width: 600, height: 400, depth: 600)
  ///
  /// Each parameter is specified in points, which translates to 1 millimeter
  /// for volumetric scenes at standard system scale. The size of a volumetric
  /// scene is immutable after creation.
  ///
  /// DefaultSize is a no-op for other window styles on mixed reality operating
system.
  ///
  /// - Parameter width: The default width for the created window.
  /// - Parameter height: The default height for the created window.
  /// - Parameter depth: The default depth for the created volumetric window.
  /// Depth is disregarded on scenes that don't support specifying depth.
  ///
  /// - Returns: A scene that uses a default size for new windows.
  public func defaultSize(
    width: CGFloat, height: CGFloat, depth: CGFloat
  ) −> some Scene {...}
  /// Sets a default size for a volumetric window.
  ///
  /// Use this modifier to indicate the default initial size for a new 3D
  /// window created from a “Scene“ using “VolumetricWindowStyle“:
  ///
  /// WindowGroup {
  /// ContentView( )
  /// }
  /// .windowStyle(.volumetric)
  /// .defaultSize(Size3D(width: 600, height: 400, depth: 600))
  ///
  /// Each parameter is specified in points, which translates to 1 millimeter
  /// for volumetric scenes at standard system scale. The size of a volumetric
  /// scene is immutable after creation.
  ///
  /// DefaultSize is a no-op for other window styles on mixed reality operating
  ///
  /// - Parameter size: The default 3D size for the created window.
  /// Depth is disregarded on scenes that don't support specifying depth.
  ///
  /// - Returns: A scene that uses a default size for new windows.
  public func defaultSize(_ size: Size3D) −> some Scene { ... }
}
‘‘‘
```

In some examples, after creation, volumetric windows cannot be resized, and within any restrictions applied by the shell, the size specified by the developer in defaultSize will be the size given for the scene. Because the system shell has the right to not honor the given size, developers will need some mechanism to determine their size at runtime. We have added GeometryReader3D as SPI, and moving this to API is likely the supported path for determining the effective size of a volumetric window. Because volumetric windows cannot be resized after creation, the windowResizability( ) modifier is disregarded and acts as a no-op.

While the volumetric window style lays the groundwork for this class of application, there are additional behaviors which have been moved out to future releases: Mixed Scale: Developers will want to be able to present dynamic scale UI within a true scale volumetric application. For example, an info sheet popping out of a point of interest on a map, where the sheet is dynamic scale but the map remains true scale. This will require significant engineering effort and is out of scope for v1. The API for mixed scale could look like:

```
‘‘‘swift
// Marking a view as dynamic scale
View( )
  .scaling(.dynamic)
// Specifying the scaling point
// This view will scale from its bottom-center
View( )
  .scaling(.dynamic, anchor: UnitPoint(x: 0.5, y: 1.0)
‘‘‘
```

Toolbar: Initial HI mock-ups for the feature included a floating pill-shaped toolbar below the content for UI elements. In some examples, this is built using the existing.toolbar( ) modifier in two-dimensional framework, but this is out of scope for v1. 3D Layout API: For v1, the 3D content displayed within a volumetric window will generally place three-dimensional kit content near the root of the app, presented within a View. In the future, we would like to offer more robust native 3D layout API to let developers build volumetric content with a toolkit more closely resembling a two-dimensional framework. User Resizability: In some examples, initially, volumetric windows will support fixed sizing using the defaultSize modifier. In some examples, support for resizability is supported. Presentations: As mentioned above, developer presentations will be mitigated and logged in v1. Longer-term, we want to allow presentations, but this will require additional engineering effort as well as HI work to determine how they should appear. In some examples, when volumetric becomes an available style on other platforms, presentations will work on them as well. Size in real units: In v1, the .defaultSize modifier takes points as the unit of measure. Particularly for volumetric scenes, since they run in true scale, developers may want to specify sizes in real-world units, rather than in points. To expose this to users, a new .defaultSize overload like the following is added:

```
‘‘‘swift
extension Scene {
  public func defaultSize(
    width: CGFloat, height: CGFloat, depth: CGFloat, in unit: UnitLength
  ) −> some Scene { }
}
‘‘‘
```

Expose a Concrete “Platter Window” Style: The .automatic style should always resolve to a concrete style when possible. For mixed reality operating system, this default style would create a typical dynamic-scale, plattered app. Marketing is currently trying to come up with a good term for this style of window, and the API should follow that name if possible. For the moment exposing this type via the .automatic style is fine. Brainstormed names for this style include: Pane, Platter, Flat, TwoDee, and Windowed.

There is no certain relation between wanting the volumetric scene behavior, and including a View. Because we want to add native 3D layout API in the future, there's no guarantee that the root view of a volumetric window will always be a View. And conversely, developers can also use View to present three-dimensional kit content within an otherwise traditional 2.5D application on the platform. This was rejected because it lacks composability. A volume app could be document-based, be a single window, or be a duplicatable window showing copies of the same contents. All these behaviors are fundamentally the same as the existing two-dimensional framework Scene types, WindowGroup, Window, and DocumentGroup and so it makes more sense to modify those types with a consistent modifier, rather than create a new set of parallel scene types. We want to avoid introducing new, special case API where we can. While this would be feasible, making windowStyle( ) available on mixed reality operating system gives us more flexibility for defining additional styles in the future. In some example, volumetric window style will be available on mixed reality operating system. It is worth some additional thought to how it could be used on other platforms as well. On computer operating system, a .volumetric window style could perhaps be used perhaps to configure a window with a 3D context for rendering. With WindowStyle being available on computer operating system and mixed reality operating system, it is worth considering if the modifier ought to be available everywhere, in the name of reducing conditional code for developers in cross-platform apps. However, because the specific styles available will still differ per-platform, this availability consideration should be considered orthogonally to exposing .volumetric on mixed reality operating system .mixed reality operating system is adding new support on UIWindowScene to display volumetric 3D content. In order to get a window scene that is configured for this, developers need a way to signal to the system shell that a given scene should gain these features. Developers also need to be able to determine at runtime whether a given scene is volumetric or not, for example in their scene:willConnectToSession: method, or when they receive the scene from another process. Volumetric scenes are built on top of the existing UIWindowScene and do not themselves require additional UIKit API or a UIWindowScene subclass, as the majority of what defines a volumetric scene is applied by the system shell. For more details on what a volumetric scene entails, see two-dimensional framework-105201522 Volumetric Scenes.

Add a new UISceneSessionRole called UIWindowSceneSessionRoleVolumetricApplication. In Swift, it is exposed as UISceneSession.Role.windowApplicationVolumetric. A scene session role is the perfect choice to indicate this kind of behavioral change. The session role is a semantic descriptor of the purpose of a scene, and does not require a UIScene subclass or additional overhead; it is a clear indicator the developer can use to signal to the system shell that the scene should be treated differently; and it is easily referenced at runtime off the scene session.

This role can be used to request a volumetric scene using the new UISceneSessionActivationRequest object (rdar://102112617 Scene Request Object API): Objective-C: UISceneSessionActivationRequest *activationRequest=[UISceneSessionActivationRequest [UIApplication.sharedApplication activateSceneSessionForRequest:activationRequest.

```
  ‘‘‘swift
  let request = UISceneSessionActivationRequest(role:
.windowApplicationVolumetric)
  UIApplication.shared.activateSceneSession(for: request) { err in ... }
  ‘‘‘
  It can also be used with an existing scene to determine whether it is avolumetric
scene:
  ‘‘‘objective-c
  if (windowScene.session.role ==
UIWindowSceneSessionRoleVolumetricApplication) {
    // The scene is volumetric, do 3D things with it
    ...
  } else {
    ...
  }
  ‘‘‘
  For two-dimensional framework users, this is also useful for those using a
UIApplicationDelegateAdaptor.
  Add the following to <UIKit/UIWindowScene.h>
  ‘‘‘swift
  extension UISceneSession.Role {
    @available(mixed reality operating system 1.0, *)
    @available(phoneOS, unavailable)
    @available(mediaOS, unavailable)
    @available(computerOS, unavailable)
    @available(wearableOS, unavailable)
    static let windowApplicationVolumetric: UISceneSession.Role
  }
  ‘‘‘
  ‘‘‘objective-c
  /// A session role for volumetric 3D scenes.
  UIKIT_EXTERN UISceneSessionRole const
UIWindowSceneSessionRoleVolumetricApplication API_AVAILABLE(mixed reality operating
system (1.0)) API_UNAVAILABLE(phoneOS, mediaOS, computerOS, wearableOS);
  ‘‘‘
```

In some examples, this change is additive, to enable new behaviors. Applications written for mixed reality operating system will need to ensure that anywhere they check session role, that they properly handle this session role in addition to the existing ones. In most cases, I would expect checks for UIWindowSceneSessionRoleApplication to want to also include UIWindowSceneSessionRoleVolumetricApplication, so mixed reality operating system apps should audit reused code that checks the session role and decide what the right course is for themselves.

Adding a new scene session role is a clear fit for the need to indicate a new type of scene with different behaviors. The alternative would be not providing an alternate public role, and having volumetric scenes also indicate UIWindowSceneSessionRoleApplication. This would be unideal, as we have clients requesting the ability to determine whether a scene they receive from out-of-process is a volumetric scene or “regular” window scene. The need to determine the type of scene at runtime is high enough that it warrants the creation of a new session role. Additionally, for developers who specify their scenes using the Scene Manifest in their Info.plist, they will use the volumetric session role to indicate volumetric scenes to the shell.

Originally, the role name included the term “Bounded” as a way to disambiguate from Boundless scenes which are also being introduced for Wolf.

Mixed reality operating system makes WindowResizability and its modifier available on the mixed reality operating system. The default value, if not specified (or if automatic is used, would be contentMinSize.

```
‘‘‘diff
@available(phoneOS 17.0, *)
@available(computerOS 13.0, *)
@available(mediaOS, unavailable)
@available(wearableOS, unavailable)
−@available(mixed reality operating system, unavailable)
+@available(mixed reality operating system 1.0, *)
extension Scene {
  public func windowResizability(
    _ resizability: WindowResizability
  ) −> some Scene
}
@available(phoneOS 17.0, *)
@available(computerOS 13.0, *)
@available(mediaOS, unavailable)
@available(wearableOS, unavailable)
−@available(mixed reality operating system, unavailable)
+@available(mixed reality operating system 1.0, *)
public struct WindowResizability: Sendable {
  public static let automatic: Self
  public static let contentSize: Self
  public static let contentMinSize: Self
}
‘‘‘
```

Window Scenes on mixed reality operating system can be resized by the user or by the application (much like computerOS). A developer needs to be able to request a new size for their window scene. Add a platform specific geometry preference object UIWindowSceneGeometryPreferences. This API will start with being able to set the size (as a CGSize), minimumSize, maximumSize, and resizingRestriction (see below). The real values for these will be reflected in the effectiveGeometry object as they change.

The geometry preference can be used to specify scene size as well as restrictions for how the user may resize the scene.

```
  ‘‘‘objective-c
    UIWindowSceneGeometryPreferences *pref =
[[UIWindowSceneGeometryPreferencesReality alloc] initWithSize:CGMakeSize(500, 500)];
    // Sets the minimumSize to 400, 400
    pref.minimumSize = CGMakeSize(400, 400)
    // Enforce that user resizes to the current programatic set aspect ratio (in this case
1:1)
    pref.resizingRestrictions = UIWindowSceneResizingRestrictionsUniform
    [windowScene requestGeometryUpdateWithPreferences:nil
errorHandler:\hat{ }(NSError * _Nonnull error) {
      // handle error
    }];
  ‘‘‘
  ‘‘‘swift
    scene.requestGeometryUpdate(.Reality(size: .init(width: 500, 500), minimumSize:
CGMakeSize(400, 400), resizingRestrictions: .uniform)) { err in
      // handle error
    }
  ‘‘‘
  Add the following to <UIKit/UIWindowSceneGeometry.h>
  ‘‘‘objective-c
  typedef NS_ENUM(NSInteger, UIWindowSceneResizingRestrictions) {
    /// App has no preference on user resize
    UIWindowSceneResizingRestrictions Unspecified = 0,
    /// The user cannot resize the scene
    UIWindowSceneResizingRestrictionsNone,
    /// User resizes are restricted to the current aspect ratio
    UIWindowSceneResizingRestrictionsUniform,
    /// In some examples, user resizes are restricted by the system and other restrictions
put in place
    UIWindowSceneResizingRestrictionsFreeform
  } API_AVAILABLE(mixed reality operating system (1.0));
  @interface UIWindowSceneGeometry ( )
  /// The current app specified minimumSize. A value of 0,0 is returned if a minimum is
not set by the application
  @property (nonatomic, readonly) CGSize minimumSize API_AVAILABLE(mixed
reality operating system (1.0));
  /// The current app specified maximumSize. A value of
CGFLOAT_MAX,CGFLOAT_MAX is returned if a maximum is not set by the application
  @property (nonatomic, readonly) CGSize maximumSize API_AVAILABLE(mixed
reality operating system (1.0));
  /// The current app specified resizingRestriction. Default value
UIWindowSceneResizingRestrictionsUnspecified
  @property (nonatomic, readonly) UIWindowSceneResizingRestrictions
resizingRestrictions API_AVAILABLE(mixed reality operating system (1.0));
  @end
  ‘‘‘
  ‘‘‘objective-c
  typedef NS_ENUM(NSInteger, UIWindowSceneResizingRestrictions) {
    /// App has no preference on user resize
    UIWindowSceneResizingRestrictionsUnspecified = 0,
    /// The user cannot resize the scene
    UIWindowSceneResizingRestrictionsNone,
    /// User resizes are restricted to the current aspect ratio
    UIWindowSceneResizingRestrictionsUniform,
    /// In some examples, user resizes are restricted by the system and other restrictions
put in place
    UIWindowSceneResizingRestrictionsFreeform
  } API_AVAILABLE(mixed reality operating system (1.0));
  @interface UIWindowSceneGeometry ( )
  /// The current app specified minimumSize. A value of 0,0 is returned if a minimum is
not set by the application
  @property (nonatomic, readonly) CGSize minimumSize API_AVAILABLE(mixed
reality operating system (1.0));
  /// The current app specified maximumSize. A value of
CGFLOAT_MAX,CGFLOAT_MAX is returned if a maximum is not set by the application
  @property (nonatomic, readonly) CGSize maximumSize API_AVAILABLE(mixed
reality operating system (1.0));
  /// The current app specified resizingRestriction. Default value
UIWindowSceneResizingRestrictionsUnspecified
  @property (nonatomic, readonly) UIWindowSceneResizingRestrictions
resizingRestrictions API_AVAILABLE(mixed reality operating system (1.0));
  @end
  ‘‘‘
  Create a new public header <UIKit/UIWindowSceneGeometryPreferencesReality.h>
  ‘‘‘objective-c
  /// Used as the value for a dimension of a size related preference when wanting to
leave it unchanged.
  UIKIT_EXTERN const CGFloat UIProposedSceneSizeNoPreference
API_AVAILABLE(mixed reality operating system (1));
  UIKIT_EXTERN API_AVAILABLE(mixed reality operating system (1.0))
  @interface UIWindowSceneGeometryPreferencesReality :
UIWindowSceneGeometryPreferences
  - (instancetype)init NS_DESIGNATED_INITIALIZER;
  /// Creates a geometry preference with a specific size (specifying
UIProposedSceneSizeNoPreference for any dimension of size, will specify no preference,
keeping that dimension the same if possible)
  - (instancetype)initWithSize:(CGSize)size;
  /// The preferred size, minimumSize, maximumSize, and resizingRestrictions. Any
dimension set to UIProposedSceneSizeNoPreference will retain the existing values.
  - (instancetype)initWithSize:(CGSize)size minimumSize:(CGSize)minimumSize
maximumSize:(CGSize)maximumSize
resizingRestrictions:(UIWindowSceneResizingRestrictions)resizingRestrictions;
  /// Create a new preference using the existing effective geometry
  - (instancetype)initWithCurrentEffectiveGeometry:(UIWindowSceneGeometry
*)effectiveGeometry;
  /// The preferred system size. Use UIProposedSceneSizeNoPreference to use existing
value
  @property (nonatomic, assign) CGSize size NS_REFINED_FOR_SWIFT;
  /// The preferred minimum size. UIProposedSceneSizeNoPreference to use default
value
  @property (nonatomic, assign) CGSize minimumSize NS_REFINED_FOR_SWIFT;
  /// The preferred maximum size. UIProposedSceneSizeNoPreference for a given to
use default value
  @property (nonatomic, assign) CGSize maximumSize NS_REFINED_FOR_SWIFT;
  /// The user resizable restrictions on the window scene
  @property (nonatomic, assign) UIWindowSceneResizingRestrictions
resizingRestrictions NS_REFINED_FOR_SWIFT;
  @end
  ‘‘‘ ‘‘‘swift
  @available(mixed reality operating system 1.0, *)
  class UIWindowScene.GeometryPreferences.Reality:
UIWindowScene.GeometryPreferences {
      var size: CGSize?
      var minimumSize: CGSize?
      var maximumSize: CGSize?
      var resizeRestrictions: ResizingRestrictions?
      init(effectiveGeometry: UIWindowScene.Geometry)
      init(size: CGSize? = nil, minimumSize: CGSize? = nil, maximumSize: CGSize?
= nil, resizeRestrictions: ResizingRestrictions? = nil)
    }
  }
  ‘‘‘
```

In some examples, this API adds platform specific preferences UIWindowSceneGeometryPreferencesReality does not have impact on other platforms.

Presently, the additions to UIWindowSceneGeometry are mixed reality operating system for. Catalyst has systemFrame which is different enough that we don't think makes sense for mixed reality operating system. There will be other API proposals to deprecate UISceneSizeRestrictions and move that functionality over to their platforms respective UIWindowSceneGeometryPreferences .rdar://108554504 (Deprecate UISceneSizeRestrictions and move content over to the platform specific UIWindowSceneGeometryPreferences) With N301 and mixed reality operating system, we are bringing two-dimensional framework into the three dimensional world, enabling new kinds of applications and experiences built using 3D content, gestures, and effects. A common use case for working in a 3D environment is to apply true 3D transforms to content. On mixed reality operating system, this is often used to: Add Z offsets to views to provide a sense of visual hierarchy and emphasis on select elements, even in a 2.5D windowed application Apply 3D rotations, scales, and offsets to content, such as when manipulating a 3D model with a gesture because two-dimensional framework on mixed reality operating system supports use of 3D content through APIs like Model3D and View (proposed separately), as well as 3D scenes like volumetric windows and unbounded Stages, it is also important to be able to apply these 3D transforms relative to a view's 3D size, such as to rotate a 3D model about its center. In some examples, mixed reality operating system supports applying 3D transforms both to 3D content (via three-dimensional kit) and to 2D views. When a 3D transform is applied to a 2D view, the view is rendered in a separate mesh and texture through a process known as “separation” baked into Core Animation and three-dimensional kit, which is leveraged internally to two-dimensional framework. We aim to expose these capabilities publicly in two-dimensional framework on mixed reality operating system with a mix of new APIs and new behaviors on existing APIs.

A suite of new View and VisualEffect modifiers for applying 3D transform effects to a view A new .visualEffect3D modifier, analogous to .visualEffect while providing access to a view's 3D geometry Amending the existing rotation3DEffect modifiers to provide a clearer story differentiating perspective rotations from true 3D rotations A new UnitPoint3D type, analogous to UnitPoint, used throughout the above APIs.

First, modifiers perform true 3D transform effects like scales, rotations, and translations on two-dimensional framework views. These are exposed both as View modifiers and as VisualEffect modifiers, as with existing transform effect modifiers like .scaleEffect( ). The simplest and most commonly used 3D transform effect is to apply a Z offset to a view. These are used throughout mixed reality operating system, such as to present sheets visually in front of its presenting view, or to have controls lift up to meet the user's finger on direct touch hover. For example:

```
  ‘‘‘swift
  Capsule( )
    .offset(z: hovering ? 10 : 0)
  We can also apply true 3D rotations using new variants of the .rotation3DEffect( )
modifier, which is particularly useful for orienting 3D content:
  ‘‘‘swift
  struct Earth: View {
    @GestureState var rotation: Rotation3D = .identity
    var body: some View {
      Model3D(“earth”)
        .rotation3DEffect(rotation)
        .gesture(RotateGesture3D( ).updating($rotation) {
          ...
        })
    }
  }
```

Note: The Rotation3D type is defined in the Spatial framework, as are other 3D geometry APIs used throughout this proposal like AffineTransform3D and Size3D. The existing .scaleEffect( ) modifier also works automatically with 3D content when using a uniform scale factor, applying that same scale in the Z axis. This enables intuitive behavior in the common case, like with applying a magnify gesture:

```
‘‘‘swift
struct Earth: View {
  @GestureState var scale = 1.0
  var body: some View {
    Model3D(“earth”)
      .scaleEffect(scale)
      .gesture(MagnifyGesture( ).updating($scale) {
        ...
      })
  }
}
‘‘‘
```

If more granular control is needed, the new .scaleEffect(x:y:z:anchor:) modifier can apply non-uniform 3D scale effects as well. Finally, modifiers are added to apply a custom AffineTransform3D 4×3 transform to a view via the .transform3DEffect( ) modifier, analogous to the .transformEffect( ) modifier for applying a 3×3 ProjectionTransform. Because these modifiers are also available as VisualEffects, they can be used within APIs like the scrollTransition modifier—for example, to apply 3D effects to views in a ScrollView:

```
‘‘‘swift
struct ContentView: View {
  var body: some View {
    ScrollView {
      ForEach(City.all) { city in
        CityCard(city)
          .scrollTransition { content, phase in
            content
              .offset(z: phase.isIdentity ? −10 : 0)
          }
      }
    }
  }
}
‘‘‘
```

In some examples, to create custom 3D geometry effects, it is important to be able to read the 3D geometry of the view, such as to apply a transform about a 3D anchor point. The new .visualEffect modifier provides access to a GeometryProxy within its closure. In some examples, this includes the view's 2D size. To address this, introduce a .visualEffect3D modifier, which behaves like .visualEffect but instead provides a GeometryProxy3D (as proposed here). This enables more advanced effects, like a recessing effect that is proportional to the depth of a Model3D:

```
‘‘‘swift
struct RecedingModelExample: View {
  @State var receded = false
  var body: some View {
    Model3D(“starship”)
      .visualEffect3D { geometry, content in
        content
          .offset(z: receded ? −geometry.depth : 0)
          .scaleEffect(recessed ? 0.5 : 1.0)
      }
    Toggle(“Receded”, isOn: $receded)
  }
}
‘‘‘
```

As noted earlier, using the rotation3DEffect name to generally represent a true 3D rotation on mixed reality operating system is advantageous, as this most accurately reflects the behavior expressed by the modifier name. To model the behavior of a true 3D rotation, new overloads with 3D types like Rotation3D are introduced:

```
‘‘‘swift
extension View {
  public func rotation3DEffect(
    _ angle: Angle, axis: RotationAxis3D, anchor: UnitPoint3D = .center)
  −> some View
  public func rotation3Deffect(
    _ rotation: Rotation3D, anchor: UnitPoint3D = .center)
  −> some View
  public func rotation3Deffect(
    _ angle: Angle, axis: (x: CGFloat, y: CGFloat, z: CGFloat),
    anchor: UnitPoint3D = .center
  ) −> some View
}
‘‘‘
```

Note that unlike the existing rotation3Deffect modifiers, in some examples, these overloads do not take a perspective value, as the concept does not have a sensible analog with a true 3D rotation. However, there are valid use cases on mixed reality operating system for preserving the existing behavior of rotation3DEffect on other platforms, where a perspective rotation is applied to the view as a 2D projection, without creating true 3D geometry. To support these use cases, a new perspectiveRotationEffect modifier is added:

```
‘‘‘swift
extension View {
  public func perspectiveRotationEffect(_ angle: Angle,
    axis: (x: CGFloat, y: CGFloat, z: CGFloat),
    anchor: UnitPoint3D = .back, perspective: CGFloat = 1)
  −> some View
}
‘‘‘
```

To help further disambiguate between perspective rotations and true 3D rotations, hard-deprecating the existing rotation3DEffect modifiers on mixed reality operating system and directing developers to use perspectiveRotationEffect instead is proposed. In some examples, this affects apps that specify a perspective value or anchor explicitly. In some examples, when an angle and axis are specified, the new rotation3DEffect overload is preferred instead when compiling for the mixed reality operating system SDK and automatically results in applying a true 3D rotation:

‘‘‘swift
SomeView( )
.rotation3DEffect(.degrees(45), axis: (x: 1, y: 0, z: 0))
‘‘‘

Note that this approach does not propose any changes to the 3D rotation APIs for other platforms at this time. See the Future directions section for additional thoughts on that subject.

To support the above APIs, a new UnitPoint3D type, serving as a 3D analog to the existing UnitPoint type is introduced. UnitPoint3D provides static members for common points, with additional variants to express the front, back, and center of a given 2D point. For example, UnitPoint3D.topLeadingBack represents the point at the back of the view in Z and the top-leading corner in X and Y, while UnitPoint3D.topLeading instead represents the center of the view in Z. Because there is some naming overlap with UnitPoint's static members, some care must be taken with modifiers that can in some places take a UnitPoint3D and in others a UnitPoint. For instance, the new.scaleEffect(x:y:z:anchor:) modifier takes a UnitPoint3D, and is marked as @_disfavoredOverload to ensure that writing code like this:

‘‘‘swift
Color.red.scaleEffect(x: 2, y: 1, anchor: .topLeading)
‘‘‘

Biases towards using the existing modifier that takes a UnitPoint and no z parameter, preserving existing semantics and expectations for apps that are also built for other platforms.

As noted earlier, the deprecation of existing rotation3DEffect modifiers on mixed reality operating system, along with an mixed reality operating system-exclusive perspectiveRotationEffect modifier, produces an inconsistency with other platforms. While we believe this is acceptable for now to help limit the scope of this proposal, we do believe it should be remedied in the future by standardizing on modifiers that are available on all platforms where possible. While more thinking is needed here, this is one possible solution: Introduce the perspectiveRotationEffect API and the new rotation3DEffect overloads that do not take a perspective value on all platforms. Note that these modifiers as proposed use the new UnitPoint3D type, which necessitates it being made available on all platforms as well. Deprecate the rotation3DEffect APIs that take a perspective value on all platforms in favor of using perspectiveRotationEffect. On 2D platforms, we would likely use soft deprecation, as using these APIs in those contexts does not meet the bar of being “actively harmful”, while we do believe that to be the case on a 3D platform like mixed reality operating system.

Animating 3D rotations can be tricky to implement correctly. Typically, 3D rotations are best animated using a spherically linear interpolation, or slerp, producing a smooth path between two 3D rotations. This requires being able to interpolate between two values in a way that is possible but difficult to implement using two-dimensional framework animation system. The rotation3DEffect modifier can implement this animation behavior automatically for most apps; however, for apps that wish to use similar animations themselves with custom 3D transforms, it may be desirable to provide this more directly. It may be possible to have the Rotation3D type from the Spatial library conform to Animatable and implement this behavior, but this has proven difficult to get right in previous attempts. A new Animatable type may be required instead. This direction needs more investigation; for now, we are using a custom opaque Animatable type for implementing rotation3DEffect's Animatable conformance.

Two-dimensional framework provides a GeometryEffect protocol, a kind of ViewModifier that can be used to apply any 3×3 ProjectionTransform as a function of the view's 2D size. All geometry effects in two-dimensional framework are currently implemented using that protocol. Behind the scenes, two-dimensional framework on mixed reality operating system also has a GeometryEffect3D protocol that follows the same design and is how the proposed modifiers like offset(z:) and transform3DEffect are implemented, with two key differences: The effect returns a 4×3 AffineTransform3D instead of a ProjectionTransform. The effect is provided a 3D size to allow it to provide transforms that are a function of the view's depth (e.g., a 3D rotation applied about the view's center in all axes). While we considered exposing this protocol publicly as well, we believe this is not necessary with the new .visualEffect3D modifier. With this modifier, apps are given even more power than with GeometryEffect3D, as they can not only determine the size of a view with the provided GeometryProxy3D, but also compute its relative frame or bounds in an ancestor coordinate space like a ScrollView. In some examples, the feature not supported by using VisualEffects at this time is the ignoredByLayout( ) modifier on GeometryEffect to have a transform effect not affect the view's layout. However, this appears to be quite uncommon to use in most apps, and it could always be added to the VisualEffect API later if it proves desirable. While we could also consider exposing GeometryEffect3D publicly in the future, it seemed better to encourage use of .visualEffect3D for now instead. (3D LAYOUT) With N301 and mixed reality operating system, we are bringing two-dimensional framework into the 3D world, enabling new kinds of applications and experiences built using 3D content, gestures, and effects. A common use case for working in a 3D environment is to apply true 3D transforms to content. On mixed reality operating system, this is often used to: Add Z offsets to views to provide a sense of visual hierarchy and emphasis on select elements, even in a 2.5D windowed application, and apply 3D rotations, scales, and offsets to content, such as when manipulating a 3D model with a gesture

Because two-dimensional framework on mixed reality operating system supports use of 3D content through APIs like ‘Model3D’ and ‘View’ (proposed separately), as well as 3D scenes like volumetric windows and unbounded Stages, it is also important to be able to apply these 3D transforms relative to a view's 3D size, such as to rotate a 3D model about its center. Behind the scenes, mixed reality operating system already supports applying 3D transforms both to 3D content (via three-dimensional kit) and to 2D views. When a 3D transform is applied to a 2D view, we render that view in a separate mesh and texture through a process known as “separation” baked into Core Animation and three-dimensional kit, which we leverage internally to two-dimensional framework. We aim to expose these capabilities publicly in two-dimensional framework on mixed reality operating systems with a mix of new APIs and new behaviors on existing APIs.

We propose: A suite of new ‘View’ and ‘VisualEffect’ modifiers for applying 3D transform effects to a view, a new ‘.visualEffect3D’ modifier, analogous to ‘.visualEffect’ while providing access to a view's 3D geometry, a mending the existing ‘rotation3DEffect’ modifiers to provide a clearer story differentiating perspective rotations from true 3D rotations, and a new ‘UnitPoint3D’ type, analogous to ‘UnitPoint’, used throughout the above APIs.

First, we introduce modifiers to perform true 3D transform effects like scales, rotations, and translations on two-dimensional framework views. These are exposed both as ‘View’ modifiers and as ‘VisualEffect’ modifiers, as with existing transform effect modifiers like ‘.scaleEffect( )’. The simplest and most commonly used 3D transform effect is to apply a Z offset to a view. These are used throughout mixed reality operating system, such as to present sheets visually in front of its presenting view, or to have controls lift up to meet the user's finger on direct touch hover. For example:
“‘swift Capsule( ).offset(z:hovering?10:0)’”

We can also apply true 3D rotations using new variants of the ‘.rotation3DEffect( )’ modifier, which is particularly useful for orienting 3D content:

```
  ‘‘‘swift struct Earth: View { @GestureState var rotation: Rotation3D = .identity var
body: some View {
Model3D(“earth”).rotation3DEffect(rotation).gesture(RotateGesture3D( ).updating($rotation) })
    }
  }
  ‘‘‘
```

**Note**: The ‘Rotation3D’ type is defined in the Spatial framework, as are other 3D geometry APIs used throughout this proposal like ‘Affine Transform3D’ and ‘Size3D’.

The existing ‘.scaleEffect( )’ modifier also works automatically with 3D content when using a uniform scale factor, applying that same scale in the Z axis. This enables intuitive behavior in the common case, like with applying a magnify gesture:

```
‘‘‘swift
struct Earth: View {
  @GestureState var scale = 1.0
  var body: some View {
    Model3D(“earth”)
      .scaleEffect(scale)
      .gesture(MagnifyGesture( ).updating($scale) {
        ...
      })
  }
}
‘‘‘
```

If more granular control is needed, the new ‘.scaleEffect (x:y:z:anchor:)’ modifier can apply non-uniform 3D scale effects as well. Finally, we also add modifiers to apply a custom ‘AffineTransform3D’ 4×3 transform to a view via the ‘.transform3DEffect( )’ modifier, analogous to the ‘.transformEffect( )’ modifier for applying a 3×3 ‘ProjectionTransform’. Because these modifiers are also available as ‘VisualEffect’s, we can use them within APIs like the ‘scrollTransition’ modifier—for example, to apply 3D effects to views in a ‘ScrollView’:

```
‘‘‘swift
struct ContentView: View {
  var body: some View {
    ScrollView {
      ForEach(City.all) { city in
        CityCard(city)
          .scrollTransition { content, phase in
            content
              .offset(z: phase.isIdentity ? −10 : 0)
          }
      }
    }
  }
}
‘‘‘
```

To create custom 3D geometry effects, it is important to be able to read the 3D geometry of the view, such as to apply a transform about a 3D anchor point. The new ‘.visualEffect’ modifier provides access to a ‘GeometryProxy’ within its closure. In some examples, this includes the view's 2D size. To address this, introduce a ‘.visualEffect3D’ modifier, which behaves like ‘.visualEffect’ but instead provides a ‘GeometryProxy3D’ (as proposed [here] (https://github.pie.apple.com/TDG/two-dimensional framework-Evolution/pull/14)). This enables more advanced effects, like a recessing effect that is proportional to the depth of a ‘Model3D’:

```
‘‘‘swift
struct RecedingModelExample: View {
  @State var receded = false
  var body: some View {
    Model3D(“starship”)
      .visualEffect3D { geometry, content in
        content
          .offset(z: receded ? −geometry.depth : 0)
          .scaleEffect(recessed ? 0.5 : 1.0)
      }
    Toggle(“Receded”, isOn: $receded)
  }
}
‘‘‘
```

As noted earlier, we propose using the ‘rotation3DEffect’ name to generally represent a true 3D rotation on mixed reality operating system, as this most accurately reflects the behavior expressed by the modifier name. To model the behavior of a true 3D rotation, we introduce new overloads with 3D types like ‘Rotation3D’:

```
‘‘‘swift
extension View {
  public func rotation3DEffect(
    _ angle: Angle, axis: RotationAxis3D, anchor: UnitPoint3D = .center)
  −> some View
  public func rotation3DEffect(
    _ rotation: Rotation3D, anchor: UnitPoint3D = .center)
  −> some View
  public func rotation3DEffect(
    _ angle: Angle, axis: (x: CGFloat, y: CGFloat, z: CGFloat),
    anchor: UnitPoint3D = .center
  ) −> some View
}
‘‘‘
```

Note that unlike the existing ‘rotation3DEffect’ modifiers, these overloads do *not* take a ‘perspective’ value, as the concept does not have a sensible analog with a true 3D rotation. However, there are valid use cases on mixed reality operating system for preserving the existing behavior of ‘rotation3DEffect’ on other platforms, where a *perspective* rotation is applied to the view as a 2D projection, without creating true 3D geometry. To support these use cases, we add a new ‘perspectiveRotationEffect’ modifier:

```
‘‘‘swift
extension View {
  public func perspectiveRotationEffect(_ angle: Angle,
    axis: (x: CGFloat, y: CGFloat, z: CGFloat),
    anchor: UnitPoint3D = .back, perspective: CGFloat = 1)
  −> some View
}
‘‘‘
```

To help further disambiguate between perspective rotations and true 3D rotations, we propose hard-deprecating the existing ‘rotation3DEffect’ modifiers on mixed reality operating system and directing developers to use ‘perspectiveRotationEffect’ instead. In some examples, this affects apps that specify a ‘perspective’ value or ‘anchor’ explicitly, however: when only an angle and axis are specified, the new ‘rotation3DEffect’ overload is preferred instead when compiling for the mixed reality operating system SDK and automatically results in applying a true 3D rotation:

‘‘‘swift
SomeView( )
.rotation3DEffect(.degrees(45), axis: (x: 1, y: 0, z: 0))
‘‘‘

Note that this approach does not propose any changes to the 3D rotation APIs for other platforms at this time. See the *Future directions* section for additional thoughts on that subject.”

To support the above APIs, we introduce a new ‘UnitPoint3D’ type, serving as a 3D analog to the existing ‘UnitPoint’ type. ‘UnitPoint3D’ provides static members for common points, with additional variants to express the front, back, and center of a given 2D point. For example, ‘UnitPoint3D.topLeadingBack’ represents the point at the back of the view in Z and the top-leading corner in X and Y, while ‘UnitPoint3D.topLeading’ instead represents the center of the view in Z. Because there is some naming overlap with ‘UnitPoint’'s static members, some care must be taken with modifiers that can in some places take a ‘UnitPoint3D’ and in others a ‘UnitPoint’. For instance, the new ‘.scaleEffect (x:y:z:anchor:)’ modifier takes a ‘UnitPoint3D’, and is marked as ‘@_disfavoredOverload’ to ensure that writing code like this:

‘‘‘swift
Color.red.scaleEffect(x: 2, y: 1, anchor: .topLeading)
‘‘‘

Biases towards using the existing modifier that takes a ‘UnitPoint’ and no ‘z’ parameter, preserving existing semantics and expectations for apps that are also built for other platforms.

As noted earlier, the deprecation of existing ‘rotation3DEffect’ modifiers on mixed reality operating system, along with an mixed reality operating system-exclusive ‘perspectiveRotationEffect’ modifier, produces an inconsistency with other platforms. While we believe this is acceptable for now to help limit the scope of this proposal, we do believe it should be remedied in the future by standardizing on modifiers that are available on all platforms where possible. While more thinking is needed here, this is one possible solution: Introduce the ‘perspectiveRotationEffect’ API and the new ‘rotation3DEffect’ overloads that do not take a ‘perspective’ value on *all* platforms. Note that these modifiers as proposed use the new ‘UnitPoint3D’ type, which necessitates it being made available on all platforms as well. Deprecate the ‘rotation3DEffect’ APIs that take a ‘perspective’ value on all platforms in favor of using ‘perspectiveRotationEffect’. On 2D platforms, we would likely use soft deprecation, as using these APIs in those contexts does not meet the bar of being “actively harmful”, while we do believe that to be the case on a 3D platform like mixed reality operating system.

Animating 3D rotations can be tricky to implement correctly. Typically, 3D rotations are best animated using a spherically linear interpolation, or [‘slerp’] (https://en.wikipedia.org/wiki/Slerp), producing a smooth path between two 3D rotations. This requires being able to interpolate between two values in a way that is possible but difficult to implement using two-dimensional framework's animation system. The ‘rotation3DEffect’ modifier can implement this animation behavior automatically for most apps; however, for apps that wish to use similar animations themselves with custom 3D transforms, it may be desirable to provide this more directly. It may be possible to have the ‘Rotation3D’ type from the Spatial library conform to ‘Animatable’ and implement this behavior, but this has proven difficult to get right in previous attempts. A new ‘Animatable’ type may be required instead. This direction needs more investigation; for now, we are using a custom opaque ‘Animatable’ type for implementing ‘rotation3DEffect’'s ‘Animatable’ conformance.

Two-dimensional framework provides a ‘GeometryEffect’ protocol, a kind of ‘ViewModifier’ that can be used to apply any 3×3 ‘ProjectionTransform’ as a function of the view's 2D size. All geometry effects in two-dimensional framework are currently implemented using that protocol. Behind the scenes, two-dimensional framework on mixed reality operating system also has a ‘GeometryEffect3D’ protocol that follows the same design and is how the proposed modifiers like ‘offset(z:)’ and ‘transform3DEffect’ are implemented, with two key differences: The effect returns a 4×3 ‘AffineTransform3D’ instead of a ‘ProjectionTransform’. The effect is provided a 3D size to allow it to provide transforms that are a function of the view's depth (e.g., a 3D rotation applied about the view's center in all axes).

While we considered exposing this protocol publicly as well, we believe this is not necessary with the new ‘.visualEffect3D’ modifier. With this modifier, apps are given even more power than with ‘GeometryEffect3D’, as they can not only determine the size of a view with the provided ‘GeometryProxy3D’, but also compute its relative frame or bounds in an ancestor coordinate space like a ‘ScrollView’.

In some examples, the feature not supported by using VisualEffect's at this time is the ‘ignoredByLayout( )’ modifier on ‘GeometryEffect’ to have a transform effect not affect the view's layout. However, this appears to be quite uncommon to use in most apps, and it could always be added to the ‘VisualEffect’ API later if it proves desirable. While we could also consider exposing ‘GeometryEffect3D’ publicly in the future, it seemed better to encourage use of ‘.visualEffect3D’ for now instead.

Developers can create standard window and volumetric window experiences on mixed reality operating system and N301, but those windows have three-dimensional bounds defined, which visually clip all of the window view hierarchy's contents. Those constraints however prevent developers from creating rich, immersive experiences, in which three-dimensional entities need to be positioned freely anywhere in the user's environment. Therefore, there is a need for a new high-level view hierarchy container primitive, which developers can define as part of their App, and which provides a space for displaying a view hierarchy without being visually clipped. Such container needs to be able to host an arbitrary two-dimensional framework view hierarchy, including View (proposal), and to be configurable to suit the developer's needs. One requirement of presenting such unbounded container is that all other applications need to be hidden by the system in order to, first and foremost, reduce glitches that can have a negative impact on the user experience due to visual intersections of contents put into the container and those of other applications, and secondly, to give the developers as much space as possible for creating rich and immersive experiences. In line with this, another peculiarity of these containers is that there can always only be none, or one, presented at a time, for the same reasons. Similarly to WindowGroup, clients need to be able to request the presentation of these containers, and to dismiss them, via newly introduced callables. This new container concept will only be available on mixed reality operating system, since there is no need for displaying unbounded content, while running exclusively, on any of our other existing platforms.

Introduce ImmersiveSpace, a new two-dimensional framework scene type that is aligned with existing window-oriented scene types, but provides the capability to display its contents with no visual border applied. This new type of scene can be used as both a primary scene, or composed with other scene types in an App. Therefore, an ImmersiveSpace can even define the entire interface of an App. Multiple ImmersiveSpace scenes can be defined by the developer, and, similarly to WindowGroup, can be defined using an identifier or a type, that they are capable of handling. The content displayed by an immersive space is defined by a newly introduced ImmersiveSpaceContent protocol, together with a new result builder for it, ImmersiveSpaceContentBuilder. Furthermore, in order to allow View based content, ImmersiveSpace ViewContent is provided, and a convenience initializers for ImmersiveSpace to display View based view hierarchies in ImmersiveSpace. Also introduce new Environment callables, openImmersiveSpace, for presenting a space based on an identifier or a type, and dismissImmersiveSpace, for dismissing the currently opened space. In some examples, to configure the individual characteristics of a space, introduce a new scene modifier that applies to ImmersiveSpace scenes though.

Similarly to a WindowGroup, developers define one or more immersive spaces in their App:

```
‘‘‘swift
@main
struct MyImmersiveApp: App {
  var body: some Scene {
    ImmersiveSpace {
      ContentView( )
    }
  }
}
‘‘‘
```

And, also similarly to WindowGroup, an ImmersiveSpace can be defined with a Hashable & Codable type that then allows developers to present an ImmersiveSpace with a value of that type:

```
‘‘‘swift
struct SolarSystem: Codable, Hashable, Identifiable {
  ...
}
@main
struct MyImmersiveApp: App {
  var body: some Scene {
    ImmersiveSpace(for: SolarSystem.ID.self) { $solarSystemID in
      SolarSystemView(solarSystem: $solarSystem)
    }
  }
}
‘‘‘
```

Immersive spaces can also be defined with a String identifier, in order for developers to disambiguate scenes and be able to open a specific immersive space targeted via an identifier:

```
‘‘‘swift
@main
struct MyImmersiveApp: App {
  var body: some Scene {
    ImmersiveSpace(id: “solarSystem”) {
      SolarSystemView( )
    }
  }
}
‘‘‘
```

An ImmersiveSpace can be configured using ImmersiveSpace specific modifiers. The immersionStyle modifier allows developers to define which styles the ImmersiveSpace supports. The style has an effect on the appearance of the content of the immersive space. The space starts with a certain style initially, and once the space is open, the style can be changed either programmatically, or by the user's interaction with software or hardware affordances. Both ways of changing the style are constrained by the set of ImmersiveSpace styles assigned to the space. We propose three different styles initially: An immersive space that is presented using the Mixed Immersion style renders its contents on top of the video pass-through of the device. This allows a mixed reality experience, in which the users can still see their surroundings, while also seeing and interacting with virtual objects and user interfaces at the same time. When an immersive space using the Full Immersion style is presented by a developer, all of the video pass-through displaying the physical real world is obscured by the system, except the hands of the user, if configured accordingly (configuration is beyond this proposal). The app does not have to, but is expected to fully cover the entire field of view with the content of the space. This style is meant to be used for fully immersive experiences with the goal of visually isolating the user from the real world. An immersive space using the Progressive Immersion style renders its contents similarly to the Full Immersion style, but does so using a portal effect. The portal offers an angular, more limited view on the virtual contents, while keeping the rest of the physical environment around the portal fully visible. The edges of the portal are feathered. The user can control the level of the immersion via hardware interaction from the initial level up to a level that matches the Full Immersion style. In this version of the platform, there is no way for the developer of knowing the current immersion level. Apart from the three styles listed above, we also propose an automatic style, AutomaticImmersionStyle, with which, once applied, developers get the default immersion style, which resolves as the Mixed Immersion style. The styles which the immersive space allows can be assigned using the new immersionStyle (selection:,in:) modifier as follows. It takes a binding for a style, and a variadic list of ImmersionStyle instances. The binding can be passed to inner views to both change and observe the currently applied style

```
‘‘‘swift
@main
struct MyImmersiveApp: App {
  @State private var currentStyle: ImmersionStyle = .mixed
  var body: some Scene {
    ImmersiveSpace(id: “solarSystem”) {
      SolarSystemView(immersionStyle: $currentStyle)
    }
    .immersionStyle(selection: $currentStyle, in: .mixed, .full)
  }
}
‘‘‘
```

By default, if no set of allowed styles was assigned, an immersive space will use the Passtrough style as the an allowed one. The variadic list of styles can be empty, which can reduce the call of the modifier to:

```
‘‘‘
  ImmersiveSpace(id: ″solarSystem″) {
    SolarSystemView(immersionStyle: $currentStyle)
  }
  .immersionStyle(selection: $currentStyle)
‘‘‘
```

Defining an empty list of styles is treated as if a single item list containing the default style, AutomaticImmersionStyle, is provided. If the binding passed to the immersionStyle modifier refers to a style that is not defined in the variadic list of styles, an error is logged, and the first style provided in the list of styles is used instead. Other than that, the order of styles in the list has no meaning. Listing the same style multiple times behaves as listing it once.

If an immersive space is the scene defined in the App, the space will be presented by the system upon app launch as the primary scene. This requires that the preferred default scene session role specified in the application's Info.plist refers to an immersive space scene session role (see rdar://89832690). The system will then create a scene that is configured as an immersive space at app launch time, and map it to the first ImmersiveSpace scene defined by the developer that matches. What happens if no such scene can be determined is not part of this proposal. For opening a specific ImmersiveSpace instance either by type or by identifier post-launch, we propose a new openImmersiveSpace callable that is part of the Environment. The different variants of this callable match the ones of the existing openWindow callable. However, as opposed to the window counter part, the openImmersiveSpace callable is designed to work asynchronously (marked as async) in order to allow developers to react to the system having processed the request to open a space, and to return a OpenImmersiveSpaceAction.Result in order to inform the developer about the outcome of the request. Developers can open an immersive space as follows:

```
‘‘‘swift
@main
struct MyImmersiveApp: App {
  @Environment(\.openImmersiveSpace) private var openImmersiveSpace
  private var solarSystem = SolarSystem(name: ″Our Solar System″,
                numberOfPlanets: 8)
  var body: some Scene {
    WindowGroup {
      VStack {
        Button(″Show Solar System″) {
          Task {
            let result = await openImmersiveSpace(id: ″solarSystem″)
            if case .error = result {
              print(″An error occurred″)
            }
          }
        }
        Button(″Show Solar System″) {
          Task {
            let result = await openImmersiveSpace(value: solarSystem.ID)
            if case .error = result {
              print(″An error occurred″)
            }
          }
        }
    }
    ImmersiveSpace(id: ″solarSystem″) {
      SolarSystemView( )
    }
    ImmersiveSpace(for: SolarSystem.ID.self) { $solarSystemID in
      SolarSystemView(solarSystem: $solarSystem)
    }
  }
}
‘‘‘
```

One peculiarity of immersive spaces that differentiate them from other Scene types is that one immersive space at a time can be presented. If a developer requests to open an immersive space while one is already shown, or about to be shown, the call to openImmersiveSpace will not succeed, an error will be logged, and an error will be return as part of the result of the openImmersiveSpace call. Developers are expected to dismiss any currently open immersive space first before opening another one. A request to open an immersive space can also fail at any time due to the current state of the system. In this case, similarly, an error will be logged, and the result of the call can be used to better understand the reason for the failure.

As done for window scenes, we are also introducing a dedicated callable for dismissing an immersive space. Similarly to the new openImmersiveSpace, the dismissImmersiveSpace is offered via the Environment, and is designed to work asynchronously in order to be able to react once dismissing is complete. As opposed to openImmersiveSpace though, dismissImmersiveSpace does not take any arguments, since it always considers the currently opened space as its target, and also does not report any success or error back, as dismissing a space is almost certainly going to succeed.

```
‘‘‘swift
@main
struct MyImmersiveApp: App {
  var body: some Scene {
    ImmersiveSpace(id: ″solarSystem″) {
      SolarSystemView( )
    }
  }
}
struct SolarSystemView: View {
  @Environment(\.dismissImmersiveSpace) private var dismissImmersiveSpace
  var body: some View {
    Button(″Dismiss Immersive Space″) {
      Task {
        await dismissImmersiveSpace( )
        print(″Dismissing complete″)
      }
    }
  }
}
‘‘‘
```

Since ImmersiveSpace is a Scene type, an immersive space receives scene phase changes the way other scene phase compatible scenes do as well. The orientation of the coordinate system of an ImmersiveSpace instance, and possible ways to determine or alter it, is not part of this proposal. While arbitrary two-dimensional framework view hierarchies can be used as the content of an immersive space, the use of View as the space's content will be encouraged to developers, as the combined capabilities of the ImmersiveSpace and View act as a great foundation for building immersive experiences on our platform. With View in a space, developers can leverage anchoring and the displaying of unbounded contents while the application is running visually exclusively. The position of a newly opened immersive space is defined by the system and can not be controlled by the application. Developers can expect a space, that is, the origin of its coordinate system, to be positioned at or near what the system has determined as the user's feet's location. If the system considers it to be required, a space can also be positioned slightly moved away from the user's feet. APIs to determine such offset are not part of this proposal. Once an immersive space is presented, the position of it can not be changed by the application. However, the system may re-position at space at any time, if it considered to be valuable to the user, e.g., after the user has physically moved away from the spawning location of the space by a significant amount, or if the user decided to re-center the experience in front of their current location. APIs to be notified about such system- or user-controlled repositioning events are not part of this proposal.

When an immersive space is requested to be opened by an application, and the space is presented, the system hides all other applications that may have previously been visually running concurrently. This ensures that the contents of the space do not visually collide or intersect with contents of any other application. It also provides a maximum of visual space for developers for creating immersive experiences. We refer to this as the application running in Exclusive Mode, versus Window Mode for applications that can run visually run side-by-side. Other scenes of the same application remain open though. Developers need to dismiss manually any of their other scenes that should not be visible while an immersive space is opened. The system provides exit actions for users to rapidly switch from Exclusive Mode to Window Mode, in order to have a guaranteed way of returning to unobfuscated video pass-through. This means that invoking such exit actions dismisses any currently presented immersive space. If any other non-ImmersiveSpace kind of scenes are currently visible when invoking, those scenes will remain unchanged. The application will therefore not be dismissed right away, but only following an intentional, second exit action on the hardware button, if a space was opened. Developers can be notified via scene phase changes of the space, if it is dismissed by the user.

While an immersive space is currently opened, it may obfuscate parts or all of video pass-through, causing the user to be visually disconnected from their physical environment. For safety reasons, and for being able to communicate with people near-by that are stepping into the user's visual field, the system may at any point partially hide the contents, or fully dismiss a space. The system at a later point will restore the full experience, once it is considered safe and appropriate to do so. Ways to be notified via APIs about partial the space contents being hidden by the system temporarily by the system are not part of this proposal. State restoration is a core functionality of the system that ensures, if properly implemented by the developer, a seamless return to the application and the user's recent activity, even in case of application termination. Similarly to other scene types, a space can be restored by the system due to the system's state restoration. This means that if an immersive space was presented when an application was exited due to system events or user interaction, it will still be presented when returning to the application at a later point. If the app was terminated in between, the space will be restored by the system automatically following the same mechanics as other scene types that support state restoration, and be visible at launch.

We propose a new ImmersiveSpace type that confirms to the Scene protocol.

In order to define the allowed styles of an ImmersiveSpace, we propose ImmersionStyle and a new Scene modifier. This modifier acts as a no-op on scenes that are not an ImmersiveSpace:

```
  ‘‘‘swift
  /// The allowed styles of an ‘ImmersiveSpace‘.
  ///
  /// Apply one or more styles that conform to this protocol to an
  ///“ImmersiveSpace“ instance to configure the appearance and behavior of the
  /// space using the “Scene/immersionStyle(selection:,in:)“ scene modifier.
  /// A type that applies a style to an ‘ImmersiveSpace‘.
  /// The style can change the appearance and behavior of the immersive space.
  ///
  /// To configure the current style of an immersive space, use the
  ///“Scene/immersionStyle(selection:,in:)“ modifier. Specify a style that
  /// conforms to ‘ImmersionStyle‘ when creating a Space.
  @available(phoneOS, unavailable)
  @available(computerOS, unavailable)
  @available(mediaOS, unavailable)
  @available(wearableOS, unavailable)
  @available(mixed reality operating system 1.0, *)
  public protocol ImmersionStyle { }
  @available(phoneOS, unavailable)
  @available(computerOS, unavailable)
  @available(mediaOS, unavailable)
  @available(wearableOS, unavailable)
  @available(mixed reality operating system 1.0, *)
  extension Scene {
    /// Sets the allowed styles for the immersive space.
    /// - Parameters:
    /// - selection: A binding to the effective style used by the space.
    /// - styles: The list of styles that the immersive space allows.
    public func immersionStyle(selection: Binding<any ImmersionStyle>,
      in styles: any ImmersionStyle...) −> some Scene
  }
  ‘‘‘
  Furthermore, we introduce three styles:
  ‘‘‘swift
  /// An immersion style that displays unbounded content intermixed with other
  /// app content, along with pass-through video.
  ///
  /// Use “ImmersionStyle/mixed“ to construct this style.
  @available(phoneOS, unavailable)
  @available(computerOS, unavailable)
  @available(mediaOS, unavailable)
  @available(wearableOS, unavailable)
  @available(mixed reality operating system 1.0, *)
  public struct MixedImmersionStyle: ImmersionStyle {
    public init( )
  }
  /// An immersion style that displays unbounded content that obscures
  /// pass-through video.
  ///
  /// Your space's content fully obscures the pass-through video
  /// except for the user's hands, if configured accordingly.
  ///
  /// Use “ImmersionStyle/full“ to construct this style.
  @available(phoneOS, unavailable)
  @available(computerOS, unavailable)
  @available(mediaOS, unavailable)
  @available(wearableOS, unavailable)
  @available(mixed reality operating system 1.0, *)
  public struct FullImmersionStyle: ImmersionStyle {
    public init( )
  }
  /// An immersion style in which the content is displayed with no clipping
  /// boundaries applied. A radial portal effect is used initially. Users can then
  /// interactively dial in and out to switch between the portal style and a style
  /// that matches the ‘FullImmersionStyle‘. In the case of the latter
  /// pass-through is obscured, except for the user's hands, if configured
  /// accordingly.
  ///
  /// Use “ImmersionStyle/progressive“ to construct this style.
  @available(phoneOS, unavailable)
  @available(computerOS, unavailable)
  @available(mediaOS, unavailable)
  @available(wearableOS, unavailable)
  @available(mixed reality operating system 1.0, *)
  public struct ProgressiveImmersionStyle: ImmersionStyle {
    public init( )
  }
  ‘‘‘
  Apart from the three concrete styles, we introduce the automatic style:
  ‘‘‘swift
  /// The default style of immersive spaces.
  ///
  /// By default, two-dimensional framework uses the “ImmersionStyle/mixed“ style
as
  /// the automatic style.
  ///
  /// Use “ImmersionStyle/automatic“ to construct this style.
  @available(phoneOS, unavailable)
  @available(computerOS, unavailable)
  @available(mediaOS, unavailable)
  @available(wearableOS, unavailable)
  @available(mixed reality operating system 1.0, *)
  public struct AutomaticImmersionStyle: ImmersionStyle {
    public init( )
  }
  ‘‘‘
  These styles are also made available via the following extensions:
  ‘‘‘swift
  @available(phoneOS, unavailable)
  @available(computerOS, unavailable)
  @available(mediaOS, unavailable)
  @available(wearableOS, unavailable)
  @available(mixed reality operating system 1.0, *)
  extension ImmersionStyle where Self == MixedImmersionStyle {
    /// An immersion style that displays unbounded content intermixed with other
    /// app content, along with pass-through video.
    public static var mixed: MixedImmersionStyle
  }
  /// An immersion style that displays unbounded content that obscures
  /// pass-through video.
  ///
  /// Your space's content fully obscures the pass-through video
  /// except for the user's hands, if configured accordingly.
  @available(phoneOS, unavailable)
  @available(computerOS, unavailable)
  @available(mediaOS, unavailable)
  @available(wearableOS, unavailable)
  @available(mixed reality operating system 1.0, *)
  extension ImmersionStyle where Self == FullImmersionStyle {
    /// An immersion style that displays unbounded content that obscures
    /// pass-through video, except for the user's hands, if configured
    /// accordingly.
    public static var full: FullImmersionStyle
  }
  /// An immersion style that displays unbounded content in a portal.
  @available(phoneOS, unavailable)
  @available(computerOS, unavailable)
  @available(mediaOS, unavailable)
  @available(wearableOS, unavailable)
  @available(mixed reality operating system 1.0, *)
  extension ImmersionStyle where Self == ProgressiveImmersionStyle {
    /// An immersion style in which the content is displayed with no clipping
    /// boundaries applied. A radial portal effect is used initially. Users can
    /// then interactively dial in and out to switch between the portal style
    /// and a style that matches the ‘FullImmersionStyle‘. In the
    /// case of the latter, passthrough is obscured, except for the user's
    /// hands, if configured accordingly.
    public static var progressive: ProgressiveImmersionStyle
  }
  /// The default immersion style.
  ///
  /// By default, two-dimensional framework uses the “ImmersionStyle/mixed“ style
as
  /// the automatic style.
  @available(phoneOS, unavailable)
  @available(computerOS, unavailable)
  @available(mediaOS, unavailable)
  @available(wearableOS, unavailable)
  @available(mixed reality operating system 1.0, *)
  extension ImmersionStyle where Self == AutomaticImmersionStyle {
    /// The default immersion style.
    public static var automatic: AutomaticImmersionStyle
  }
  ‘‘‘
```

If a user has not defined any allowed style on an immersive space, the automatic style will be used as the only allowed style, which resolves to the same runtime behavior as the Mixed Immersion style. For opening an immersive space, we propose adding a new OpenImmersiveSpaceAction, that is made available as a newly introduced openImmersiveSpace callable. For accessing the openImmersiveSpace callable, we propose augmenting the Environment with a new openImmersiveSpace key:

Similarly to dismissWindow, developers can use the dismissBehavior transaction property that allows for dismissing an immersive space regardless of the presence of modals.

It may be an option to loosen the current requirement of the application entering Exclusive Mode when an ImmersiveSpace is presented. This could be useful for applications where the space has a rather decorative character, and other applications running visually side-by-side at the same time may be a valid request. In certain use cases, it may be desirable to have control over the positioning and orientation of the space when opening it, and when the user physically, or any of the other scenes, are being moved around. For example, a space that displays simply visual effects, such as glow, fire or fog, may require a positioning system in relation to existing other scenes. Developers may want to define custom animation settings when the style of a space is changed from one to another.

The procedure of finding a fitting name for this new concept was a lengthy and challenging one. Instead of calling it a space, next to many other ideas, the following names were more thoroughly considered: Stage-Stage was the internal name used to develop the feature prior to considering API naming. The idea behind this is that ordinary, planar scenes appear on a stage. Due to conflicts with the user-facing Stage Manager feature on phoneOS and computerOS, and the possibility that Stage Control related APIs may be required, and due the hierarchy the word stage implies (scenes semantically happen all on stage, but the API implies rather a peer relationship), the name stage was ultimately discarded. ImmersiveScene—the idea of including “immersive” in the API name may be appealing for naming APIs specifically for this platform. However, this would rule out bringing the API to other platforms that do not provide any immersion capabilities. Additionally, the suffix “Scene” would be unfortunate, given that existing scene types do not use it either. Panorama—Panorama was considered as a name since it describes the feature quite well, comparing it with the definition of it (“immersive experiences”, “360 degree”). Another benefit of panorama is that it is not in use in UI frameworks yet for API naming, and would allow us to expand the API in future further without risking conflicts with existing API naming. However, in order to be closer aligned with marketing and product naming decisions, the name panorama was discarded in favor of space. MixedReality, VirtualReality and VirtualRealityPortal were considered as names for the three styles of immersive spaces. However, to better align with marketing terminology, we renamed these to the currently suggested terms instead.

Similarly to .formsheet or .popover, the described functionality of a space to display unbounded contents and entering Exclusive Mode could alternatively be achieved via a .immersiveSpace View modifier:

```
    ‘‘‘swift
  var body: some View {
    @State private var showingImmersiveSpace: Bool = false
    Button(″Show Immersive Space″) {
      showingImmersiveSpace.toggle( )
    }
    .immersiveSpace(isPresented: $showingImmersiveSpace, presentation: .backdrop)
{
      View {
        // ...
      }
    }
    .onAppear { ... }
    .onDisappear { ... }
  }
  ‘‘‘
```

One advantage of this could be code locality: The space is defined right where it is presented. However, there are several drawbacks with this direction, which is why we decided against it: The same space and space content may need to be presented from numerous places throughout the application logic, so having a more high-level primitive seems more developer-friendly. Embedding the conceptionally independent view hierarchy of a space locally in an existing view hierarchy seems odd and against separation of responsibilities. Dismissing the view hierarchy from which the space was originally opened is not easily doable. Features such as state restoration, scene phases, and more, are not easily applicable. It became clear that we want ImmersiveSpace to be a first class, prominent, high-level primitive that acts as a building block for the application's user interface just as much as WindowGroup, Window, and other Scene types.

Another alternative is to create a space by creating a Window instance first, and then apply an immersion style on it, which would give the window the unique space characteristics. However, since we believe that ImmersiveSpace and Window may further diverge in future, we consider it is worth having a dedicated Scene type ImmersiveSpace instead. Note that this means however, that any window modifier can be applied to a space and the space related modifiers can be applied to any other window type. For the combinations that would not make sense, these would simply be no-ops.

Instead of openImmersiveSpace( . . . ) async->OpenImmersiveSpace.Result, we also considered openImmersiveSpace( ) async throws. This however would require the developer to always use try for this callable, but callables have usually been designed as succinct as possible. The benefit of instead indicating success or failure via a return value is that the method can be marked with @discardableResult, so that clients that have no interest in the result can benefit from a more minimalist code for opening a space. Also note that the set of possible errors in the context of opening a space is rather limited (as opposed to, say, file I/O errors, as in the case for the openDocument( ) async throws callable).

Instead of openImmersiveSpace( . . . ) async->OpenImmersiveSpaceAction.Result, we also considered openImmersiveSpace( ) async->Swift.Result<Void, OpenImmersiveSpaceError>. However, Swift.Result requires a value type for the success case, which in the case of openImmersiveSpace would be Void. We believe that a custom OpenImmersiveSpaceAction.Result with three custom tailored cases more straight forward to use for developers (e.g., .opened for the success case), than a Swift. Result, with which developers would have to compare against .success(Void). The system's default behavior is to hand over a bounded, planar ‘UIWindowScene’ to the application at launch time, with the ‘UIWindowSceneSessionRoleApplication’ scene session role applied. Developers however will want to configure their application to launch with a single immersive space scene, in order to jump directly into an immersive mixed reality or virtual reality experience. Therefore, a static signal is needed for the system-shell to know what kind of scene to initially create. Static because the scene session role may also influence other aspects of the system experience such as scene placeholders, which need to be displayed prior to launch. By introducing a new scene session role for ‘ImmersiveSpace’ scenes, the developer can provide such signal by referring to this role via the new ‘UIPreferredDefaultSceneSessionRole’ key (see rdar://89832690) in their application's ‘Info.plist’. The system-shell will then read the defined value prior to launch, look up the correct scene configuration in the scene manifest, and instantiate a correctly configured scene at launch time. The application is then handed over a scene of the expected type and can embed its user interface. This proposal focuses on the introduction of the scene session role, and its usage for configuring the application's ‘Info.plist’. Requesting an immersive space scene using the new scene session role at runtime is not covered by this proposal.

Introduce a new ‘UISceneSessionRole’ called ‘UISceneSessionRoleImmersiveSpaceApplication’. In Swift, it is exposed as ‘UISceneSession.Role.immersiveSpaceApplication’. Developers would use the new scene session role in their application's ‘Info.plist’ as a _value_ for the ‘UIPreferredDefaultSceneSessionRole’ key. Developers may also use the scene session role as a _key_ in the dictionary defining the scene configurations their application's ‘Info.plist’. Add the following to “‘<UIKit/UIScene.h>’”

‘‘‘objective-c
/// A session role for Immersive Space scenes.

UIKIT_EXTERN UISceneSessionRole const UISceneSessionRoleImmersiveSpaceApplication API_AVAILABLE (mixed reality operating system (1.0)) API_UNAVAILABLE (phoneOS, computerOS, mediaOS, wearableOS);

```
‘‘‘
‘‘‘swift
extension UISceneSession.Role {
  @available(phoneOS, unavailable)
  @available(computerOS, unavailable)
  @available(mediaOS, unavailable)
  @available(wearableOS, unavailable)
  @available(mixed reality operating system 1.0, *)
  static let immersiveSpaceApplication: UISceneSession.Role
}
‘‘‘
```

This change is purely additive, to enable new behaviors. Existing applications running on will need to ensure that anywhere they check a session role, that they properly handle this new session role in addition to the existing ones. Alternatively to naming it ‘UISceneSessionRoleImmersiveSpaceApplication’, we could also call it ‘UIWindowSceneSessionRoleImmersiveSpaceApplication’ or ‘UIImmersiveSpaceSceneSessionRoleImmersiveSpaceApplication’. However, since we likely will not introduce any API for a dedicated immersive space scene in UIKit in Borealis, the decision whether this class should be a ‘UIScene’ or a ‘UIWindowScene’ subclass has not been made yet, and choosing any of ‘UIWindowSceneSessionRoleImmersiveSpaceApplication’ or ‘UIImmersiveSpaceSceneSessionRoleImmersiveSpaceApplication’ now would imply some constraints for the future API design of a class for such scene type. Calling it ‘UISceneSessionRoleImmersiveSpaceApplication’ for now would ensure that even _if_ we ever introduce a dedicated class for this new kind of scene, the name would still be valid (as in, the new class would definitely directly or indirectly inherit from ‘UIScene’).

Instead of introducing a new scene session role for allowing launching into an immersive experience via a new scene session role, we could also provide no new API around this feature at all, and instead always launch applications with an ordinary ‘UIWindowScene’. Once launched, developers could then offer a user affordance at runtime to open an immersive space scene. Developers could even destroy the scene session role backing the ‘UIWindowScene’ as soon as they get a chance to together with requesting an immersive space scene, which would come very close to what we are trying to offer, at least from a user experience point of view. However, we considered this as a very unfortunate work-around which we do not want to establish in our developer's minds. Also, _always_ handing over a regular ‘UIWindowScene’ to the applications could cause unclear situations, if a two-dimensional framework based application uses ‘ImmersiveSpace’ scene as its only scene.

The system-shell needs _some_static signal prior to app launch in order to enable the “launching into an immersive experience” use case. An alternative to providing a new scene session role could be to offer instead a different key-value pair, e.g., ‘UIApplicationLaunchIntoImmersiveExperience’, or something similar. However, in order to pave the way for a future UIKit Immersive Space scene API, we considered it as the right thing to do instead to start off with a dedicated scene session role which hopefully will not have to be deprecated once new immersive space related UIKit APIs will be introduced. ImmersiveSpaceDisplacement On, developers create immersive experiences using a new type of scene that is called ‘ImmersiveSpace’ (see [ImmersiveSpace proposal] (https://github.pie.apple.com/TDG/two-dimensional framework-Evolution/pull/3)). When opening an immersive space scene, by default, the system positions the scene at the user's feet, or at least somewhere nearby. The developer has no control over the position of the immersive space scene.

A user may be currently in either a single-user experience, or participate in a shared group experience, using the Group Activities framework. In order to ensure spatial truth during a shared group experience, the system may move the immersive space, and therefore, the general user experience, slightly away from the user's own current location and also rotate it. In this context, we refer with “ego-centric” to the user's own current location in world space, and with “experience-centric” to the center of the (possibly shared) user experience. Accordingly, the two do not have to always match.

Knowing the difference between the two locations may however be necessary for developers to position content within the immersive space relatively to the user or the experience. Therefore, we propose API to read the pose (a translation and a rotation) that the system has currently applied on the immersive space.

Introduce a new ‘immersiveSpaceDisplacement (in:)’ API on ‘GeometryProxy3D’, which is introduced with [this proposal] (https://github.pie.apple.com/TDG/two-dimensional framework-Evolution/pull/14).

Developers use this method to obtain the pose applied by the system to move and rotate the immersive space scene to a more appropriate location. The pose is expressed with ‘Pose3D’, which is a structure defined in the Spatial library. The method takes a coordinate space as an argument in order to specify what coordinate space the returned pose should be expressed in.

A use case of this might look as follows, which displays the content of a game in a immersive space scene, together with a HUD view. The game content appears at the center of the shared group activity (“experience-centric”), whereas the HUD will appear at the ego-centric position by taking the displacement into account.

```
‘‘‘swift
struct GameApp: App {
  var body: some Scene {
    ImmersiveSpace {
      GeometryReader3D { proxy in
        let displacement =
          proxy.immersiveSpaceDisplacement(in: .global)
        let inverseDisplacement = displacement.inverse
        Container3D {
          GameContentView( )
          GameHUDView( )
            .offset(inverseDisplacement.position)
            .rotation3DEffect(inverseDisplacement.rotation)
        }
      }
    }
  }
}
‘‘‘
‘‘‘swift
extension GeometryProxy3D {
  /// Returns the pose applied by the system to displace the origin of the
  /// immersive space. By default, the immersive space is centered near the
  /// user's feet, or somewhere close to it. In this case, ‘.identity‘ is
  /// returned. In shared experiences, the center of the experience may be
  /// moved by the system to a more appropriate location.
  /// If there is no immersive space currently opened, this returns
  ///‘.identity‘.
  ///
  /// - Parameters:
  /// - space: A coordinate space that the returned pose is relative to
  @available(phoneOS, unavailable)
  @available(computerOS, unavailable)
  @available(mediaOS, unavailable)
  @available(wearableOS, unavailable)
  @available(mixed reality operating system 1.0, *)
  func immersiveSpaceDisplacement(in space: some CoordinateSpaceProtocol)
    −> Pose3D
}
‘‘‘
```

Future enhancements may provide access to the poses of other participants of a shared group experience.

Instead of ‘experienceDisplacement(in:)’, we also considered other names, but none of them seemed like a perfect fit. In order for this API to stay ‘ImmersiveSpace’ independent, we considered “experience displacement” rather than “immersive space displacement”, but the idea was discarded, since “experience” is not something we use anywhere else yet. Adding a ‘system’ prefix, was but decided against it, given that it is in fact the system that controls the center of the experience.

This would no longer require developers to invert the pose before applying it on UI that is supposed to be positioned “ego-centric'ly”. However, the naming of such API was even more challenging, since “user pose” could suggest that it updates when the user moves (or changes their head pose), even though it does not—the returned pose really only changes when the Space is displaced, but the user can still move freely to a certain degree with no changes. A clear, none-misleading name for such API could not be found, which is why we stick to the current approach.

Rather than a ‘Pose3D’, which consists of a position (‘Position3D’) and a rotation (‘Rotation3D’), we also considered returning a ‘AffineTransform3D’ instead. However, given that an instance of ‘AffineTransform3D’ also embodies a scale, which is not anything that the system would apply on the overall user experience, we figured that a pose is enough to express the data.

An alternative to adding a method on ‘GeometryReader3D’ could be to provide the pose applied by the system via the two-dimensional framework environment instead. However, there would be no way to specify the coordinate space relatively to which the pose should be returned.

Alternatively, we considered introducing a ‘ImmersiveSpaceReader’, which similarly to ‘GeometryReader’ and ‘GeometryReader3D’, would provide a proxy object offering a single method similar to the one suggested by this proposal. However, we figured that there is no strong argument introduce such new concept just for the sake of this API, and due to the geometric nature of the new API, the ‘GeometryReader3D’ was considered a good fit.

The scene manifest, which is an optional part of the application's ‘Info.plist’, provides a static description of some of the application's aspects that can be indexed and read by the system prior to launching the application. Part of the scene manifest are the scene configurations, which already allow developers to define a name for the configuration, a custom scene class and a custom scene delegate class. The system takes these settings into account during the launch path for setting up the first scene.

With the introduction of ‘UIApplicationPreferredDefaultSceneSessionRole’ key (see rdar://83741369), developers can choose which scene session role the system-shell should consider when creating the first scene of the application. If a developer chooses the immersive space scene session role (see rdar://107833628), a immersive space scene will be created, which connects to the application at launch. Once an immersive space scene is created by the system-shell, certain aspects of it cannot be changed anymore, including the style of it. Therefore, there is a need for having the necessary configuration readily readable prior to the creation of the immersive space scene.

We propose to provide a new key, ‘UISceneInitialImmersionStyle’, and new values, ‘UIImmersionStyleMixed’, ‘UIImmersionStyleFull’ and ‘UIImmersionStyleProgressive’, that developers can optionally use as part of a scene configuration to configure an immersive space scene statically prior to its creation.

For an application that wants to launch right into a Virtual Reality user experience, the immersive space scene related ‘Info.plist’ declaration may look as follows:

```
‘‘‘
  ...
  <key>UIApplicationPreferredDefaultSceneSessionRole</key>
  <string>UISceneSessionRoleImmersiveSpaceApplication</string>
  <key>UISceneConfigurations</key>
  <dict>
    <key>UISceneSessionRoleImmersiveSpaceApplication</key>
    <array>
      <dict>
        <key>UISceneConfigurationName</key>
        <string>Immersive Space Configuration</string>
        <key>UISceneInitialImmersionStyle</key>
        <string>UIImmersionStyleFull</string>
      </dict>
    </array>
    ...
  </dict>
  ...
‘‘‘
```

Note that in Borealis, two-dimensional framework's ‘ImmersiveSpace’ scene does not allow developers to define a custom scene delegate class nor a custom scene sub-class. Also, Borealis comes with no support for storyboards. Hence, the existing ‘Info.plist’ scene manifest keys ‘UISceneClassName’, ‘UISceneStoryboardFile’ and ‘UISceneDelegateClassName’ are being ignored by the system for immersive space scenes.

Also note that this proposal covers the new keys and possible values for the scene manifest section of an application's ‘Info.plist’. There are no additional symbols for the runtime API necessary.

Add new optional ‘Info.plist’ keys and a set of allowed, valid values for specifying an immersive space scene configuration.

```
  | Key | Type | Values |
  | UISceneInitialImmersionStyle | String |One of {UIImmersionStyleMixed,
UIImmersionStyleFull, UIImmersionStyleProgressive} |
```

The configuration will be evaluated by the system, but no guarantees can be made about them being honored. If a value cannot be honored, the system will choose a meaningful fallback configuration, and log an error.

None, since this is a new feature.

Instead of ‘UISceneInitialImmersionStyle’, a shorter name, ‘UIImmersiveSpaceSceneImmersionStyle’, was also considered. But that name could be misleading, since it suggests that the referenced style is the only style the immersive space scene supports. However, the developer defines the _initial_ immersive space style with this key, whereas in the developer's two-dimensional framework-based sources, the immersive space may define additionally supported styles, that the immersive space can switch to at runtime.

Instead of ‘UIImmersiveSpaceSceneImmersionStyle’, ‘UISceneImmersiveSpaceStyle’ was also considered, in order to have shared prefix for all keys in a scene manifest's scene configuration. However, a dedicated ‘UIImmersiveSpaceScene’ prefix for the key acts as a good indicator that this is a key applicable on an immersive space kind of scene only, and would also align the key better with the naming of the key's possible values.

We could do nothing, but this would mean that clients could only launch with an immersive space scene with a system-defined default configuration applied, which developers would have no control over. Given that this is a new platform, we do not want to make assumptions about what such default configuration would ideally look like to cover most of the use cases.

We could allow more key-value based configuration, including hands visibility and video pass-through dimming, but these are aspects of a stage that can also be easily controlled by the developer after the immersive space scene's creation, that is, at runtime. We prefer to start with a minimal set of API and add only what is necessary based on feedback we gather post launch of the platform.

Instead of a scene configuration, we could also offer other ‘Info.plist’ keys and values, (e.g., at the root level of the property list, to define a configuration for the initial immerse space scene). However, given that the concept of scene configurations already exists, and given the semantic fit for it, and given that there are plans to possibly offer an ‘ImmersiveSpace’ scene API in UIKit post Borealis, using the existing scene configuration pattern for this ask seemed appropriate.

On mixed reality operating system, developers create immersive experiences using a new type of scene that is called ImmersiveSpace (see ImmersiveSpace proposal). ImmersiveSpace scenes can coexist with regular windowed scenes but there is no way to get the coordinates of any regular view in the coordinate space of the ImmersiveSpace scene. Providing such an API enables an application to move 3D objects in between planar Window scenes and the global ImmersiveSpace and create richer interaction in between the UI of the app and the virtual world.

Introduce a new NamedCoordinateSpace named .immersiveSpace. Developers use this property to obtain the CoordinateSpace corresponding to the currently opened immersive space. .imersiveSpace is above .global in the hierarchy of coordinate spaces. If there is no currently opened ImmersiveSpace scene in the application, using .immersiveSpace for a transform will give the same result as using .global

A possible use case of this API is the following: A developer would like to position an entity part of a view hierarchy in an ImmersiveSpace scene relatively to content that is presented in a WindowGroup scene, or any other window providing scene. For example, a car model that is added to immersive space, in order to be rendered without the limitations of the clipping boundaries of a window, could be positioned close to an inspector window, which allows a user to learn about selected details of the car. A developer would use the new API to obtain the transform of the inspector user interface in the coordinate space of the ImmersiveSpace scene. The transform can then be applied using the right geometry and layout modifiers, to position the car next to the inspector.

@available(phoneOS, unavailable)
@available(computerOS, unavailable)
@available(mediaOS, unavailable)
@available(wOS, unavailable)
@available(mixed reality operating system 1.0, *)
extension CoordinateSpaceProtocol where Self == NamedCoordinateSpace {
/// The named coordinate space that represents the currently opened
/// “ImmersiveSpace“ scene.
/// If no immersive space is currently opened, using this CoordinateSpace
/// will return the same result as using the “.global“ coordinate space.
public static var immersiveSpace: NamedCoordinateSpace
}

We considered the use of a property of GeometryProxy3D instead but we found the use of a CoordinateSpace felt more natural the platform and two-dimensional framework API. We also considered redefining .global but the idea was rejected because the implications for the behaviour of .global on other platforms like macOS were problematic and we didn't want to create a behaviour exception for mixed reality operating system.

FIG. 8 illustrates an electronic system 800 with which one or more implementations of the subject technology may be implemented. The electronic system 800 can be, and/or is a part of, the electronic device 105, the handheld electronic device 104, the electronic device 110, the electronic device 115, and/or the server 120 as shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 1000. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random-access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810 (which are each implemented as a non-transitory computer-readable medium). From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the electronic system 1000. Input devices that may be used with the input device interface 814 may include, for example, alphanumeric keyboards and pointing devices (also called “cursor control devices”). The output device interface 806 may enable, for example, the display of images generated by electronic system 1000. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, such as the electronic device 110 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some examples, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how a device interacts with a user. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be displayed to users by inferring location based on non-personal information data or a bare minimum amount of personal information, such as the content being requested by the device associated with a user or other non-personal information.

1. A method, comprising:
receiving, from a first application, a request to render a first object in an environment; and
in response to receiving the request to render the first object in the environment, rendering the first object;
after rendering the first object and while the first object is being displayed in the environment, detecting an indication of a request to change a size of content provided by the first application; and
in response to detecting the indication of the request to change the size of content provided by the first application, rendering a representation of the environment by:
in accordance with a determination that the environment is rendered according to a first mode and that the first object is a first type of object, wherein the environment corresponds to the first application and a second application different from the first application while the environment is rendered according to the first mode, maintaining a physical size of the first object without maintaining an angular size of the first object;
in accordance with a determination that the environment is rendered according to the first mode and that the first object is a second type of object different from the first type of object, maintaining the angular size of the first object without maintaining the physical size of the first object; and
in accordance with a determination that the environment is rendered according to a second mode, wherein the environment corresponds to the first application without corresponding to another application different from the first application while the environment is rendered according to the second mode, maintaining the physical size of the first object without maintaining the angular size of the first object.

2. The method of claim 1, wherein the second mode is a window mode, and wherein the first object is within a window while the environment is rendered according to the second mode.

3. The method of claim 1, further comprising:
while a second object is being displayed in the environment, detecting a second indication of a request to change a size of content, wherein the second indication is different from the indication; and
in response to detecting the second indication of the request to change the size of content, rendering a second representation of the environment by:
in accordance with a determination that the environment is rendered according to the second mode and that the second object is a third type of object, maintaining a physical size of the second object without maintaining an angular size of the second object; and
in accordance with a determination that the environment is rendered according to the second mode and that the second object is a fourth type of object different from the first type of object, maintaining the angular size of the first object without maintaining the physical size of the first object, wherein the fourth type of object is different from the third type of object.

4. The method of claim 1, while a third object is being displayed concurrently with the first object in the environment and in response to detecting the indication of the request to change the size of content provided by the first application, rendering the representation of the environment by:
while maintaining the angular size of the first object, maintaining a physical size of the third object without maintaining an angular size of the third object; and
while maintaining the physical size of the first object, maintaining the angular size of the third object without maintaining the physical size of the third object.

5. The method of claim 1, further comprising:
while a fourth object of a second application is being displayed concurrently with the first object in the environment and in response to detecting an indication of a request to change a size of content, wherein the second application is different from the first application, rendering the representation of the environment by:
while maintaining the angular size of the first object, maintaining a physical size of the fourth object without maintaining an angular size of the fourth object; and
while maintaining the physical size of the first object, maintaining the angular size of the fourth object without maintaining the physical size of the fourth object.

6. The method of claim 5, wherein the content provided by the first application is concurrently displayed in the environment with content provided by the second application.

7. The method of claim 1, further comprising:
while the environment is rendered according to the first mode, detecting a request to transition to the second mode; and
in response to detecting the request to transition to the second mode, causing the environment to operate in the second mode, wherein causing the environment to operate in the second mode includes removing, from the environment, content provided by another application different from the first application.

8. The method of claim 1, wherein, while the environment is rendered according to the first mode: content corresponding to the first application is in a first area of the environment and not in a second area of the environment and content corresponding to a second application is in the first area and not in the second area, wherein the second area is different from the first area, and wherein the second application is different from the first application.

9. The method of claim 1, wherein, while the environment is rendered according to the first mode and in accordance with a determination that a first set of one or more criteria is satisfied, content provided by the first application is within a three-dimensional bounded window.

10. The method of claim 1, wherein, while in the first mode and in accordance with a determination that a second set of one or more criteria is satisfied, content corresponding to the first application is within a two-dimensional bounded window, and wherein the second set of one or more criteria is different from the first set of one or more criteria.

11. The method of claim 10, wherein the first set of one or more criteria includes a criterion that is satisfied when a first window corresponding to the first application includes a style defining that the window is a three-dimensional bounded window, and wherein the second set of one or more criteria includes a criterion that is satisfied when a second window corresponding to the first application includes a style defining that the second window is a two-dimensional bounded window.

12. The method of claim 8, wherein the second area surrounds the first area.

13. The method of claim 1, wherein:
maintaining the physical size of the first object without maintaining the angular size of the first object includes:
at a first time while the size of content provided by the first object is changed, maintaining the physical size of the first object and maintaining the angular size of the first object.

14. The method of claim 13, wherein:
maintaining the physical size of the first object without maintaining the angular size of the first object includes:
at a second time, different from the first time, while the size of content provided by the first object is changed, changing the angular size of the first object while maintaining the physical size of the first object.

15.-18. (canceled)

19. A non-transitory computer-readable storage medium storing one or more programs configured to be executed by one or more processors of a computer system, the one or more programs including instructions for:
receiving, from a first application, a request to render a first object in an environment; and
in response to receiving the request to render the first object in the environment, rendering the first object;
after rendering the first object and while the first object is being displayed in the environment, detecting an indication of a request to change a size of content provided by the first application; and
in response to detecting the indication of the request to change the size of content provided by the first application, rendering a representation of the environment by:
in accordance with a determination that the environment is rendered according to a first mode and that the first object is a first type of object, wherein the environment corresponds to the first application and a second application different from the first application while the environment is rendered according to the first mode, maintaining a physical size of the first object without maintaining an angular size of the first object;
in accordance with a determination that the environment is rendered according to the first mode and that the first object is a second type of object different from the first type of object, maintaining the angular size of the first object without maintaining the physical size of the first object; and
in accordance with a determination that the environment is rendered according to a second mode, wherein the environment corresponds to the first application without corresponding to another application different from the first application while the environment is rendered according to the second mode, maintaining the physical size of the first object without maintaining the angular size of the first object.

20. A computer system, comprising:
one or more processors; and
memory storing one or more programs configured to be executed by the one or more processors, the one or more programs including instructions for:
receiving, from a first application, a request to render a first object in an environment; and
in response to receiving the request to render the first object in the environment, rendering the first object;
after rendering the first object and while the first object is being displayed in the environment, detecting an indication of a request to change a size of content provided by the first application; and
in response to detecting the indication of the request to change the size of content provided by the first application, rendering a representation of the environment by:
in accordance with a determination that the environment is rendered according to a first mode and that the first object is a first type of object, wherein the environment corresponds to the first application and a second application different from the first application while the environment is rendered according to the first mode, maintaining a physical size of the first object without maintaining an angular size of the first object;
in accordance with a determination that the environment is rendered according to the first mode and that the first object is a second type of object different from the first type of object, maintaining the angular size of the first object without maintaining the physical size of the first object; and
in accordance with a determination that the environment is rendered according to a second mode, wherein the environment corresponds to the first application without corresponding to another application different from the first application while the environment is rendered according to the second mode, maintaining the physical size of the first object without maintaining the angular size of the first object.

21.-42. (canceled)
